(19) United States
(12) Patent Application Publication
(10) Pub. No.: US 2025/0344005 A1
(43) Pub. Date: Nov. 6, 2025

(54) ACOUSTIC SEAL FOR ELECTRONIC DEVICE

(71) Applicant: Apple Inc., Cupertino, CA (US)

(72) Inventors: Brandon Z. Frank, San Francisco, CA (US); Xi Xi, San Francisco, CA (US); Lee B. Hamstra, Palo Alto, CA (US)

(21) Appl. No.: 19/096,650

(22) Filed: Mar. 31, 2025

Related U.S. Application Data
(60) Provisional application No. 63/643,237, filed on May 6, 2024.

(51) Int. Cl. H04R 1/02

(52) U.S. Cl. CPC H04R 1/02

(57) ABSTRACT

Speaker seals and electronic devices including speaker seals are disclosed. In an example, an electronic device includes a housing sidewall defining a plurality of openings, an electronic positioned adjacent to the housing sidewall, and a seal between the electronic and the housing sidewall. The seal can include a first adhesive layer on the housing sidewall, a first mesh layer on the first adhesive layer, a second adhesive layer on the first membrane layer, and a second mesh layer on the second adhesive layer. One of the first adhesive layer or the second adhesive layer can define an opening having a length that encircles more than one of the openings.

### CROSS-REFERENCE TO RELATED APPLICATIONS

This application claims the benefit of U.S. Provisional Application No. 63/643,237, filed 6 May 2024, entitled “ACOUSTIC SEAL FOR ELECTRONIC DEVICE,” the entire disclosure of which is hereby incorporated by reference.

### FIELD

The described embodiments relate generally to acoustic seals for electronic devices, such as personal electronic devices. More particularly, the present embodiments relate to acoustic seals having improved water resistance with minimal acoustic impedance, which provide portable electronic devices with improved ingress protection without negatively impacting acoustic performance.

### BACKGROUND

Electronic devices such as computers, tablet computers, media players, cellular telephones, wearable devices, and headphones are often provided with speakers for generating sound output from the electronic device. The speakers can be provided adjacent to openings in the electronic devices, which can create pathways for water and other contaminants to enter the electronic devices. The water and other contaminants can damage components of the electronic devices, such as processors, memory, antennas, display, and other components. The speaker openings in electronic devices can be sealed. However, this can create acoustic impedance and reduce the quality of audio produced by the speakers. Accordingly, it can be desirable to provide electronic devices with seals for speaker openings that increase ingress protection, without negatively impacting audio quality produced from the speakers.

### SUMMARY

In at least one example of the present disclosure, an electronic device includes a housing sidewall defining a first opening and a second opening, an electronic positioned adjacent to the housing sidewall, and a seal disposed between the electronic and the housing sidewall. The seal can include a first adhesive layer engaging the housing sidewall, a first mesh layer on the first adhesive layer opposite the housing sidewall, and a second adhesive layer on the first mesh layer opposite the first adhesive layer, and a second mesh layer on the second adhesive layer opposite the first mesh layer. The first adhesive layer or the second adhesive layer defines an orifice that encircles the first opening and the second opening.

In some examples, the electronic device can further include a third adhesive layer on the second mesh layer opposite the second adhesive layer, and a third mesh layer on the third adhesive layer opposite the second mesh layer. In some examples, the first mesh layer has a first acoustic impedance, the second mesh layer has a second acoustic impedance greater than the first acoustic impedance, and the third mesh layer has a third acoustic impedance greater than the first acoustic impedance and the second acoustic impedance.

In some examples, the other of the first adhesive layer or the second adhesive layer can define a second plurality of openings. In some examples, the one of the first adhesive layer or the second adhesive layer can further define a third opening and a fourth opening.

In some examples, both the first adhesive layer and the second adhesive layer can each define an orifice that encircles the first opening and the second opening. In some examples, a length of the orifice can be greater than a length of the first mesh layer or the second mesh layer.

In at least one example of the present disclosure, a speaker seal includes a first adhesive layer, a first mesh layer adhered to the first adhesive layer, the first mesh layer having a first length, a second adhesive layer including an opening having a second length greater than the first length, and a second mesh layer adhered to the second adhesive layer. The second mesh layer can have a higher acoustic impedance than the first mesh layer.

In some examples, the speaker seal can further include a third mesh layer adhered to the first adhesive layer opposite the first mesh layer. In some examples, the third mesh layer can have a lower acoustic impedance than both the first mesh layer and the second mesh layer. In some examples, the third mesh layer, the second mesh layer, and the second adhesive layer can have a third length greater than the second length.

In some examples, the second adhesive layer can include a protrusion defining a second opening having a third length less than the second length. The protrusion can cover at least a portion of the second mesh layer. In some examples, the first adhesive layer can include a plurality of openings. In some examples, the speaker seal can have an acoustic impedance of less than 65 Rayls and an ingress protection rating of at least IPX4.

In at least one example of the present disclosure, an electronic device includes a housing sidewall defining a first speaker opening, a second speaker opening, a third speaker opening, a housing rear wall, a speaker module attached to the housing rear wall, and a speaker seal attached to the housing sidewall. The speaker seal can include a first adhesive layer attached to the housing sidewall and a first mesh layer attached to the first adhesive layer. The first adhesive layer can include a channel having a length that encircles two of the first speaker opening, the second speaker opening, and the third speaker opening.

In some examples, the electronic device can further include a second adhesive layer attached to the housing sidewall. The second adhesive layer can encircle the first adhesive layer and the first mesh layer. In some examples, the second adhesive layer can include a channel having a length that encircles the first speaker opening, the second speaker opening, and the third speaker opening, the first adhesive layer, and the first mesh layer. In some examples, the second adhesive layer can include a protrusion aligned with an outermost speaker opening of the plurality of speaker openings.

In some examples, the electronic device can further include a second mesh layer attached to the second adhesive layer. The second mesh layer can have a second acoustic impedance greater than a first acoustic impedance of the first mesh layer.

In some examples, the electronic device can further include a third adhesive layer attached to the housing sidewall and a third mesh layer attached to the third adhesive layer. The first adhesive layer and the second adhesive layer can be attached to the housing sidewall through the third mesh layer. In some examples, the second adhesive layer can include a protrusion aligned with the first speaker opening.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A is a perspective view of an electronic device.

FIG. 1B is a top-down view of a portion of the electronic device of FIG. 1A.

FIG. 1C is a cross-sectional view of a portion of the electronic device of FIG. 1A.

FIG. 1D is a perspective, partially exploded view of a portion of the electronic device of FIG. 1A.

FIGS. 2A and 2B are a cross-sectional view and an exploded view, respectively, of a portion of an electronic device including a seal.

FIGS. 3A and 3B are a cross-sectional view and an exploded view, respectively, of a portion of an electronic device including a seal.

FIGS. 4A and 4B are a cross-sectional view and an exploded view, respectively, of a portion of an electronic device including a seal.

FIGS. 5A and 5B are a cross-sectional view and an exploded view, respectively, of a portion of an electronic device including a seal.

FIGS. 6A and 6B are a cross-sectional view and an exploded view, respectively, of a portion of an electronic device including a seal.

FIGS. 7A, 7B, 7C, and 7D are a cross-sectional and exploded views of a portion of an electronic device including a seal.

FIGS. 8A, 8B, 8C, and 8D are a cross-sectional and exploded views of a portion of an electronic device including a seal.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a speaker seal for a speaker opening of an electronic device. The speaker seal can be formed from one or more layers of adhesive and one or more layers of mesh. The adhesive layers can include openings that direct water and other contaminants within the speaker seal. The mesh layers can provide specific levels of ingress protection, while having minimal acoustic impedance. Because water and other contaminants are directed in a desired manner within the speaker seal by the openings in the adhesive layer, mesh layers with lower acoustic impedance can be used to provide a desired level of ingress protection. Thus, the speaker seal can have improved ingress protection, while having minimal acoustic impedance through the speaker opening. The speaker seal can be used to prevent water and other contaminants from entering an internal volume of the electronic device and can prevent damage to internal components of the electronic device.

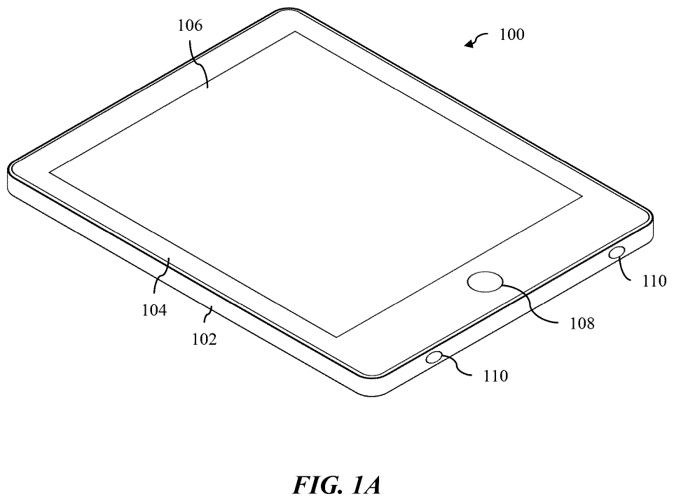

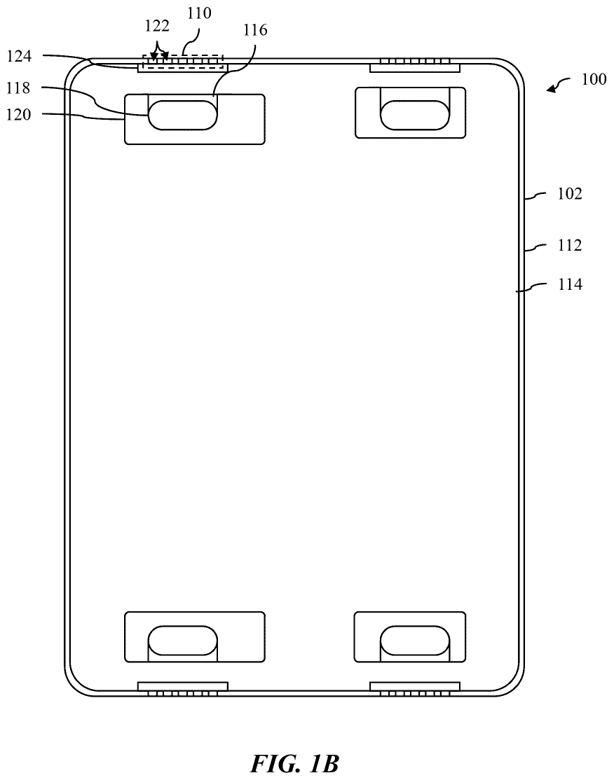

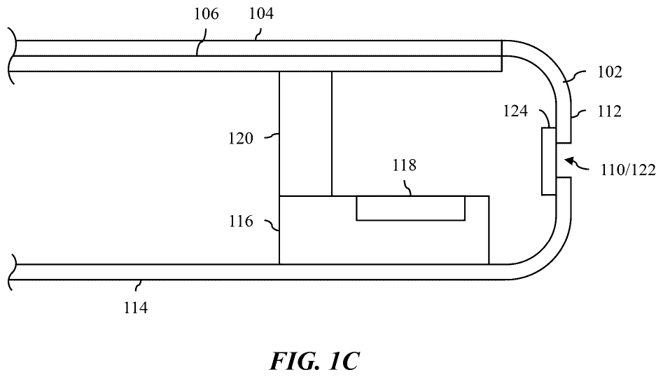

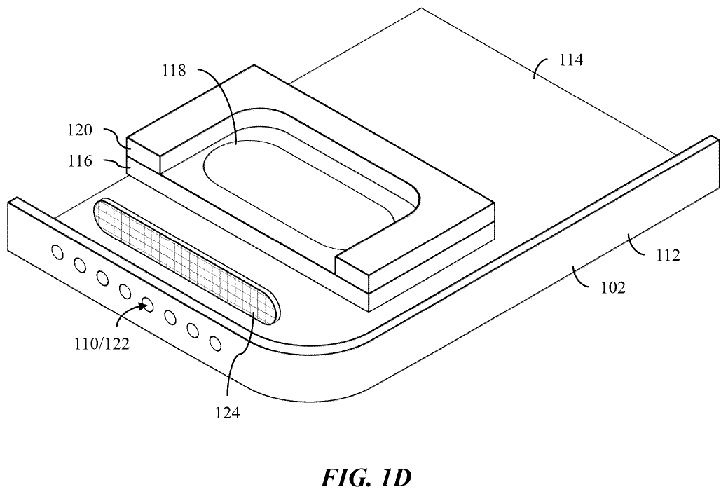

Specific examples and embodiments of speaker seals and electronic devices including speaker seals are discussed below with reference to FIGS. 1A through 8D. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A through 1D show an example of an electronic device 100. The electronic device shown in FIGS. 1A through 1D is a tablet computer. The tablet computer of FIGS. 1A through 1D is merely one representative example of a device that can be used in conjunction with the systems and methods disclosed herein. The electronic device 100 can correspond to any form of a wearable electronic device (e.g., watches, such as smartwatches), a cellular telephone, a smart phone, a portable media player, a media storage device, a portable digital assistant (“PDA”), a tablet computer, a computer, a mobile communication device, a GPS unit, a remote control device, or another electronic device. The electronic device 100 can be referred to as an electronic device, a device, a consumer device, a tablet computer, or the like.

The electronic device 100 can include a housing 102, a cover glass 104, a display assembly 106, a button 108, and speaker openings 110. The housing 102 can be referred to as an enclosure, a case, or the like. The housing 102 can be formed from materials such as plastic, glass, ceramics, fiber composites, metals (e.g., stainless steel, aluminum, titanium, combinations or alloys thereof, or the like), other suitable materials, combinations thereof, or the like. The enclosure can receive the cover glass 104. The display assembly 106 can be positioned between the housing 102 and the cover glass 104. The display assembly 106 can be configured to drive visual display content visible through the cover glass 104.

The electronic device 100 can include one or more input/output devices, such as a touch screen incorporated into the display assembly 106, a button or switch (e.g., the button 108), and/or other input/output components disposed on, behind, or within the housing 102, the cover glass 104, and/or the display assembly 106. The housing 102, the cover glass 104, and/or the display assembly 106 can include one or more openings to accommodate the button 108, speakers, microphones, a light source, a camera, and the like.

In the example illustrated in FIG. 1A, the housing 102 includes two speaker openings 110 on a bottom sidewall of the housing 102. The speaker openings 110 can form ports for audio components. For example, the speaker openings 110 can form speaker ports for speakers disposed within the housing 102. In some examples, the housing 102 can include a speaker opening 110 that can form a microphone port for a microphone disposed within the housing 102.

As will be discussed in greater detail with respect to FIGS. 1B through 1D, the speaker openings 110 can be open ports that can be completely or partially covered with a mesh structure or other permeable membrane that allows air and sound to pass through the speaker openings 110, without allowing water and other contaminants to pass through the speaker openings 110. Although two speaker openings 110 are shown in FIG. 1A, this is merely illustrative. One speaker opening 110, two speaker openings 110, or more than two speaker openings 110 may be provided on the bottom sidewall (illustrated in FIG. 1A), another sidewall (e.g., a top, left, or right sidewall), a rear surface of the housing 102 and/or a front surface of the electronic device 100 (e.g., on or within the cover glass 104 and/or the display assembly 106). In some examples, one or more groups of the speaker openings 110 in can be aligned with a single port of an audio component within the housing 102.

FIG. 1B illustrates a top-down view of the electronic device 100 with the cover glass 104 and the display assembly 106 removed. FIG. 1C illustrates a cross-sectional view of a portion of the electronic device 100. FIG. 1D illustrates a partially exploded view of a portion of the electronic device 100. For purposes of clarity and simplicity, internal components (e.g., processors, batteries, a memory device, and the like) have been removed. The electronic device 100 can include sidewalls 112, a rear portion 114, speaker modules 116, acoustic guides 120, speaker openings 122, and speaker seals 124. The sidewalls 112 can generally represent a four-sided sidewall structure that defines an outer peripheral portion of the housing 102. The rear portion 114 can be opposite the cover glass 104 and the display assembly 106. The rear portion 114 may generally be associated with a portion of the housing 102 within the sidewalls 112. The speaker openings 110 can be defined in or by the sidewalls 112 (e.g., a top sidewall 112 and a bottom sidewall 112). Each of the speaker openings 110 can include a group of individual speaker openings 122. Any number of speaker openings 122 can be included in each of the speaker openings 110. An audio component, such as a speaker module 116, a microphone, or the like, can be associated with each of the speaker openings 110.

The speaker modules 116 can be positioned on the rear portion 114 of the housing 102 proximal the speaker openings 110. The speaker modules 116 can be electrically connected to an internal component of the electronic device 100, such as an audio processor (not separately illustrated). In some examples, the speaker modules 116 can each include one or more diaphragms 118, which can be actuated to generate sound. The diaphragms 118 can be configured to drive sound from the electronic device 100 that can be heard by users. The speaker modules 116 can be acoustically coupled to the display assembly 106, the cover glass 104, and/or the rear portion 114 of the housing 102, and can cause the display assembly 106, the cover glass 104, and/or the rear portion 114 to resonate. This can improve the bass quality of sound produced by the speaker modules 116. In the example illustrated in FIG. 1B, the electronic device 100 can include four speaker modules 116, located generally at the four corners of the electronic device 100. However, the electronic device 100 can include more or fewer speaker modules 116, and the speaker modules 116 can be located in any desired positions in the electronic device 100.

In some embodiments, the speaker modules 116 can be mounted on or secured to the housing 102, such as through an adhesive, fasteners, or the like. In some examples, at least portions of the speaker modules 116 can be formed using a machining process (e.g., CNC tooling, waterjet machining, or the like) configured to remove material from the housing 102 to form the speaker modules 116. In other words, the speaker modules 116 can be integrally formed with the housing 102 and can be formed from the same materials as the housing 102. The speaker modules 116 can be formed from one or more materials, such as plastics, metals, or the like.

An acoustic guide 120 can be mounted on or attached to each of the speaker modules 116. The acoustic guides 120 can at least partially surround or encircle the diaphragms 118. The acoustic guides 120 can direct sound produced by the speaker modules 116 (e.g., the diaphragms 118) towards the speaker openings 110. The acoustic guides 120 can contact a back surface of the display assembly 106 (e.g., a surface of the display assembly 106 opposite a display surface of the display assembly 106). The acoustic guides 120 and the speaker modules 116 can provide structural support as well as resistance to bending and/or twisting to the housing 102, the display assembly 106, and/or the cover glass 104. The acoustic guides 120 can be formed from acoustic foams or the like and can be formed from polymer materials such as polyether, polyester, or the like. The acoustic guides 120 can provide additional acoustical enhancements, such as sound absorption, in order to configure audio devices that output the same sound levels. The acoustic guides 120 can be adhesively secured to the speaker modules 116. The acoustic guides 120 can be generally u-shaped, as illustrated in FIGS. 1B and 1D, can be rectangular, or can have any other suitable shape depending on the acoustic characteristics the acoustic guides 120 are configured to provide.

The speaker seals 124 can be attached to the sidewalls 112 of the housing 102 and can cover the speaker openings 122 of the speaker openings 110. Each of the speaker seals 124 can cover all of the speaker openings 122 of a respective speaker opening 110 and can overlap onto the sidewalls 112 of the housing 102. A periphery of each speaker seal 124 can encircle, surround, or encompass a periphery of each of the respective speaker openings 110 (e.g., in a plan view of the speaker seals 124 and the sidewalls 112). The speaker seals 124 can be provided to prevent ingress of water and other contaminants through the speaker openings 110. The speaker seals 124 can be formed from one or more adhesive layers and one or more mesh layers, which can be configured to provide maximum ingress protection while minimizing acoustic impedance. The speaker seals 124 can be attached to the sidewalls 112 by the adhesive layers of the speaker seals 124.

The adhesive layers of the speaker seals 124 can be formed from any suitable adhesives, such as pressure-sensitive adhesives, heat-activated film adhesives, ultra-violet (UV)-cured adhesives, epoxies, hot melts, or the like. The adhesive layers can be formed from impermeable materials (e.g., impermeable to air, water, contaminants, and the like), and can include openings. The openings can be configured to guide water and contaminants that enter the speaker seal 124 through the speaker openings 110/122. Specifically, the openings can guide water and contaminants that enter the speaker seal 124 along the mesh layers and can redirect the water and contaminants out of the speaker openings 110/122.

The mesh layers of the speaker seals 124 can provide desired levels of ingress protection, while including minimal acoustic impedance. The acoustic impedance of the speaker seals 124 and the layers included therein can be measured in terms of a Rayl value, with lower Rayl values indicating less acoustic impedance. Generally, mesh layers with higher Rayl values provide greater ingress protection, while mesh layers with lower Rayl values provide less ingress protection. The overall acoustic impedance of the speaker seals 124 can be approximated by adding the acoustic impedance of each of the layers of the respective speaker seals 124, although acoustic impedance of the layers of the speaker seals 124 can be non-linear.

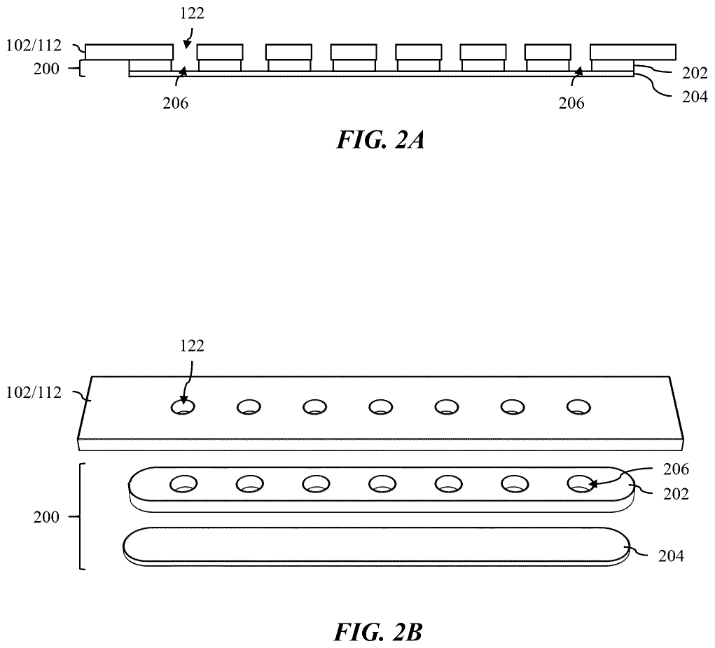

The speaker seals 124 can include multiple mesh layers, which can be configured to provide various functions. For example, an outer mesh layer of a speaker seal 124 can be configured to break up an incoming pressurized flow, providing a pressure drop, and decreasing a flowrate of the incoming pressurized flow. The outer mesh layer can have a relatively low ingress protection and Rayl value. An inner mesh layer of the speaker seal 124 can be configured to prevent seepage through the speaker seal 124. The inner mesh layer can have a relatively high ingress protection and Rayl value. By including the outer and inner mesh layers, an incoming flow of water and contaminants can be slowed down, and then prevented from seeping through the speaker seal 124. Any number of mesh layers having any desired characteristics (e.g., ingress prevention characteristics, Rayl values, and the like), in any desired order, can be used in the speaker seal 124. Additional details of the mesh layers and the adhesive layers that can be used in the speaker seals 124 are discussed below with respect to FIGS. 2A through 8D.

The mesh layers of the speaker seals 124 can be formed from various materials. For example, the mesh layers can be formed from interwoven filaments and can be formed from materials such as polymers (e.g., polyethylene terephthalate (PET), polyethylene (PE), polypropylene (PP), polyether ether ketone (PEEK), polyester, nylon, or the like), metals (e.g., stainless steel aluminum, or the like), or the like. The filaments can include monofilaments or multifilaments. The filaments can have diameters from about 40 μm to about 260 μm. The filaments of the outer mesh layers can have diameters relatively larger than the inner mesh layers. For example, the outer mesh layers can have filaments with diameters from about 40 μm to about 260 μm, from about 40 μm to about 110 μm, from about 45 μm to about 255 μm, or from about 43 μm to about 105 μm. The inner mesh layers can have filaments with diameters from about 35 μm to about 65 μmm, from about 40 μm to about 60 μm, or from about 43 μm to about 58 μm.

The filaments of the mesh layers of the speaker seals 124 can be coated or uncoated. For example, hydrophobic coatings (e.g., deposited by physical vapor deposition (PVD), chemical vapor deposition (CVD), or the like) can be provided on the filaments of the mesh layers. In some examples, outer mesh layers of the speaker seals 124 can include uncoated materials, which can reduce costs, simplify production processes, and improve or alter cosmetics of the outer mesh layers. Inner mesh layers of the speaker seals 124 can include coated materials, which can increase ingress protection of these mesh layers. Both the outer mesh layers and the inner mesh layers can include hydrophobic coatings, and the inner mesh layers can have relatively greater hydrophobicity than the outer mesh layers. The outer mesh layers can have a water contact angle (WCA) from about 85° to about 140° or from about 90° to about 130°. The inner mesh layers can have a WCA from about 120° to about 150°, from about 120° to about 140°, or greater than about 130°.

The mesh layers of the speaker seals 124 can include woven materials, which can have various weave patterns. In some examples, the mesh layers can include stamped meshes, 3D printed meshes in a two-dimensional or three-dimensional weave, extruded meshes, die-cut meshes, spun meshes, woven meshes, or any other suitable mesh materials. For example, the mesh layers can have a plain 1/1 weave, a twill 2/1 weave, a twill 2/2 weave, or any other desired weave pattern. Plain weave meshes can have a higher non-linearity factor for acoustic impedance relative to twill weave meshes that is more pronounced in higher impedance meshes. As such, mesh layers with higher acoustic impedance can be woven with twill weave patterns. Mesh layers with lower acoustic impedance can be woven with plain or twill weaves. In some examples, the outer mesh layers of the speaker seals 124 can be woven with plain or twill weaves and the inner mesh layers of the speaker seals 124 can be woven with twill weaves.

The weave patterns, yarn diameters, coatings, and the like of the mesh layers of the speaker seals 124 can be used to form the mesh layers with different opening sizes, open area percentages, and the like. For example, different weave patterns can form openings in the mesh layers with square shapes, rectangular shapes, or the like. The openings in the mesh layers can be generally rectangular. The opening sizes can be defined as an average area of each of the openings in the mesh layer. The area of each opening can be determined by multiplying a width of each opening by a length of the opening. The open area percentages of the mesh layers can be determined by dividing a total open area of the mesh layer by a total area of the mesh layer.

The outer mesh layers of the speaker seals 124 can have larger opening sizes (also referred to as pore sizes), larger open area percentages, greater filament diameters, and lower acoustic impedance relative to the inner mesh layers. For example, the outer mesh layers can have pore sizes from about 30 μm to about 300 μm, from about 34 μm to about 285 μm, from about 34 μm to about 105 μm, or from about 50 μm to about 285 μm; open area percentages from about 30% to about 65% or from about 32% to about 60%; and acoustic impedance from about 2 Rayls to about 35 Rayls, from about 3 Rayls to about 30 Rayls, from about 12 Rayls to about 30 Rayls, or from about 3 Rayls to about 15 Rayls. The inner mesh layers can have pore sizes from about 15 μm to about 40 μm or from about 18 μm to about 34 μm; open area percentages from about 15% to about 35% or from about 18% to about 32%; and acoustic impedance from about 25 Rayls to about 160 Rayls or from about 30 Rayls to about 155 Rayls.

The weave pattern, pore size, and open area percentage across each of the mesh layers of the speaker seals 124 can be uniform or varying. For example, providing the mesh layer with areas with tighter weave patterns (associated with reduced pore sizes and decreased open area percentages) and looser weave patterns can help to redirect water and contaminant flow through the mesh layer. The mesh layer can have a looser weave pattern in areas where water and contaminants are desired to flow, such as proximal to a channel that redirects water out of the mesh layer. The mesh layer can have a tighter weave pattern in an area immediately proximal to an opening in an overlying adhesive layer, and the weave pattern can become looser as the distance from the opening increases. In some examples, the mesh layers can be embossed. In examples in which the mesh layer is embossed, the mesh layer can have a tighter weave pattern in areas that will be embossed, such that the mesh layer has a relatively uniform weave after the mesh layer is embossed. Providing the mesh layer with a weave that has a varying density can improve ingress protection and reduce acoustic impedance provided by the speaker seal 124.

FIGS. 2A and 2B illustrate a cross-sectional view and an exploded view, respectively, of a speaker seal 200 that includes one adhesive layer 202 and one mesh layer 204. The adhesive layer 202 and the mesh layer 204 can be formed from any of the materials of the speaker seals 124, discussed above in reference to FIGS. 1B through 1D. The speaker seal 200 can be attached to a sidewall 112 of a housing 102. The speaker seal 200 can encircle, surround, or encompass a plurality of speaker openings 122 in the sidewall 112 (e.g., in a plan view of the speaker seal 200 and the sidewall 112). The adhesive layer 202 includes an opening 206 for each of the speaker openings 122. The speaker seal 200 can be adhered to the sidewall 112 by the adhesive layer 202. The speaker seal 200 can be used to seal the speaker openings 122 of the housing 102 (e.g., from water, contaminants, and the like) while allowing sound to travel through the speaker openings 122.

As illustrated in FIGS. 2A and 2B, the adhesive layer 202 and the mesh layer 204 can have lengths and widths that extend past peripheries of the speaker openings 122. The peripheries of the adhesive layer 202 and the mesh layer 204 can encircle, surround, or encompass the peripheries of the speaker openings 122 (e.g., in a plan view of the speaker seal 200 and the sidewall 112). The adhesive layer 202 can be adhered to the sidewall 112 of the housing 102 such that the adhesive layer 202 encircles, surrounds, or encompasses each of the speaker openings 122. This ensures that any water or contaminants that enter the speaker openings 122 cannot bypass the speaker seal 200 and enter an internal volume of an electronic device that includes the housing 102. Although the adhesive layer 202 and the mesh layer 204 are illustrated as being capsule-shaped, the adhesive layer 202 and the mesh layer 204 can have any suitable shape, such as a rectangular shape, an oval shape, or the like.

In the example of FIGS. 2A and 2B, an opening 206 is provided in the adhesive layer 202 for each of the speaker openings 122. The openings 206 can have greater areas than the speaker openings 122. The openings 206 and the speaker openings 122 can have circular shapes. As illustrated in FIGS. 2A and 2B, the openings 206 can have greater diameters than the speaker openings 122; however, in some examples, the openings 206 can have diameters equal to or less than diameters of the speaker openings 122. Each of the openings 206 can be aligned with a respective speaker opening 206. Water and contaminants passing through the speaker openings 122 can be directed by the openings 206 to the mesh layer 204.

The mesh layer 204 can be formed from a mesh having a relatively high acoustic impedance and high ingress protection. The mesh layer 204 can be provided to break the flow of incoming water and contaminants, provide a pressure drop to the flow of incoming water and contaminants, and prevent seepage through the speaker seal 200 and into an internal volume of an electronic device. The mesh layer 204 can be formed with a twill weave pattern. In some examples, the mesh layer 204 can be formed with a plain weave pattern. The mesh layer 204 can be formed from filaments with diameters from about 35 μm to about 65 μm, from about 40 μm to about 60 μm, or from about 43 μm to about 58 μm. The mesh layer 204 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 204 can include a hydrophobic coating and can have a WCA from about 120° to about 150°, from about 120° to about 140°, or greater than about 130°. The mesh layer 204 can be provided with a minimum acoustic impedance to provide a desired level of ingress protection for the speaker seal 200.

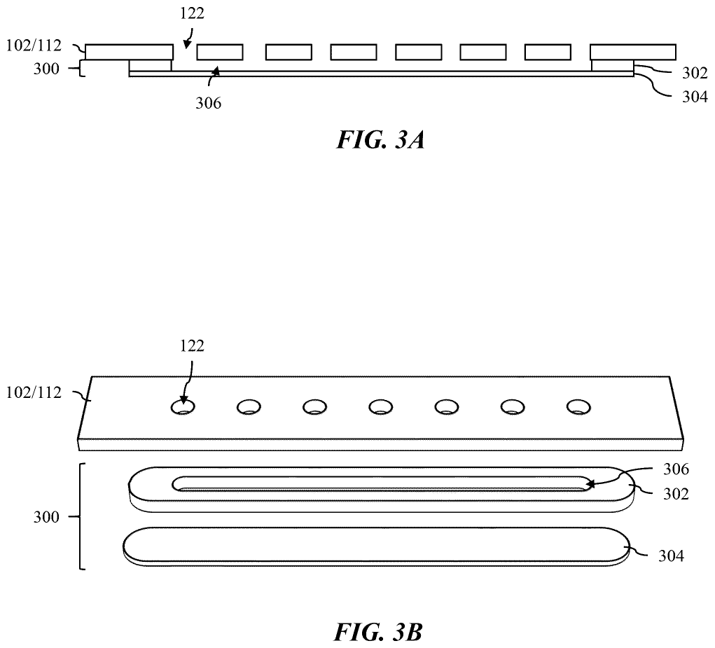

FIGS. 3A and 3B illustrate a cross-sectional view and an exploded view, respectively, of a speaker seal 300 that includes one adhesive layer 302 and one mesh layer 304. The adhesive layer 302 and the mesh layer 304 can be formed from any of the materials of the speaker seals 124, discussed above in reference to FIGS. 1B through 1D. The speaker seal 300 can be attached to a sidewall 112 of a housing 102. The speaker seal 300 can encircle, surround, or encompass a plurality of speaker openings 122 in the sidewall 112 (e.g., in a plan view of the speaker seal 300 and the sidewall 112). The adhesive layer 302 includes or defines an orifice or opening 306 for the plurality of speaker openings 122. The speaker seal 300 can be adhered to the sidewall 112 by the adhesive layer 302. The speaker seal 300 can be used to seal the speaker openings 122 of the housing 102 (e.g., from water, contaminants, and the like) while allowing sound to travel through the speaker openings 122.

As illustrated in FIGS. 3A and 3B, the adhesive layer 302 and the mesh layer 304 can have lengths and widths that extend past peripheries of the speaker openings 122. The peripheries of the adhesive layer 302 and the mesh layer 304 can encircle, surround, or encompass the peripheries of the speaker openings 122 (e.g., in a plan view of the speaker seal 300 and the sidewall 112). The adhesive layer 302 can be adhered to the sidewall 112 of the housing 102 such that the adhesive layer 302 encircles, surrounds, or encompasses the group of speaker openings 122. This ensures that any water or contaminants that enter the speaker openings 122 cannot bypass the speaker seal 300 and enter an internal volume of an electronic device that includes the housing 102. Although the adhesive layer 302 and the mesh layer 304 are illustrated as being capsule-shaped, the adhesive layer 302 and the mesh layer 304 can have any suitable shape, such as a rectangular shape, an oval shape, or the like.

The mesh layer 304 can be formed from a mesh having a relatively high acoustic impedance and high ingress protection. The mesh layer 304 can be provided to break the flow of incoming water and contaminants, provide a pressure drop to the flow of incoming water and contaminants, and prevent seepage through the speaker seal 300 and into an internal volume of an electronic device. The mesh layer 304 can be formed with a twill weave pattern. In some examples, the mesh layer 304 can be formed with a plain weave pattern. The mesh layer 304 can be formed from filaments with diameters from about 35 μm to about 65 μm, from about 40 μm to about 60 μm, or from about 43 μm to about 58 μm. The mesh layer 304 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 304 can include a hydrophobic coating and can have a WCA from about 120° to about 150°, from about 120° to about 140°, or greater than about 130°. The mesh layer 304 can be provided with a minimum acoustic impedance to provide a desired level of ingress protection for the speaker seal 300.

In the example of FIGS. 3A and 3B, a single orifice or opening 306 is provided in the adhesive layer 302 for the group of speaker openings 122 (e.g., a speaker openings 110). The orifice or opening 306 can have a length equal to or greater than a length between a left edge of a leftmost speaker opening 122 and a right edge of a rightmost speaker opening 122. The orifice or opening 306 can have a width equal to or greater than a diameter of each of the speaker openings 122. As such, the orifice or opening 306 can surround, encircle, or encompass the plurality of speaker openings 122 (e.g., in a plan view of the speaker seal 300 and the sidewall 112). The orifice or opening 306 can have a capsule-shape, as illustrated in FIGS. 3A and 3B, or any other suitable shape such as a rectangular shape, an oval shape, or the like. The speaker openings 122 can have circular shapes. Water and contaminants passing through the speaker openings 122 can be directed by the orifice or opening 306 to the mesh layer 304. By providing a single opening 306 that extends under multiple speaker openings 122, water and contaminants that enter through one of the speaker openings 122 can pass through the orifice or opening 306 and be directed out of another of the speaker openings 122 without passing through the mesh layer 304. In other words, the orifice or opening 306 and the mesh layer 304 can redirect water and contaminants entering through a speaker opening 122 out of another of the speaker openings 122. This allows for a mesh layer with a lower acoustic impedance and ingress protection rating to be used for the mesh layer 304, while still providing improved ingress protection, improving sound quality through the speaker seal 300.

In further detail, the orifice or opening 306 can create a flow channel within the adhesive layer 302. For example, when a pressurized flow of water and contaminants enters a leftmost speaker opening 122, a channel can be formed through the orifice or opening 306 out of a rightmost speaker opening 122. This channel can help water and contaminants to be flushed out of the speaker seal 300, reducing seepage through the mesh layer 304, and providing improved ingress protection within minimal acoustic impedance.

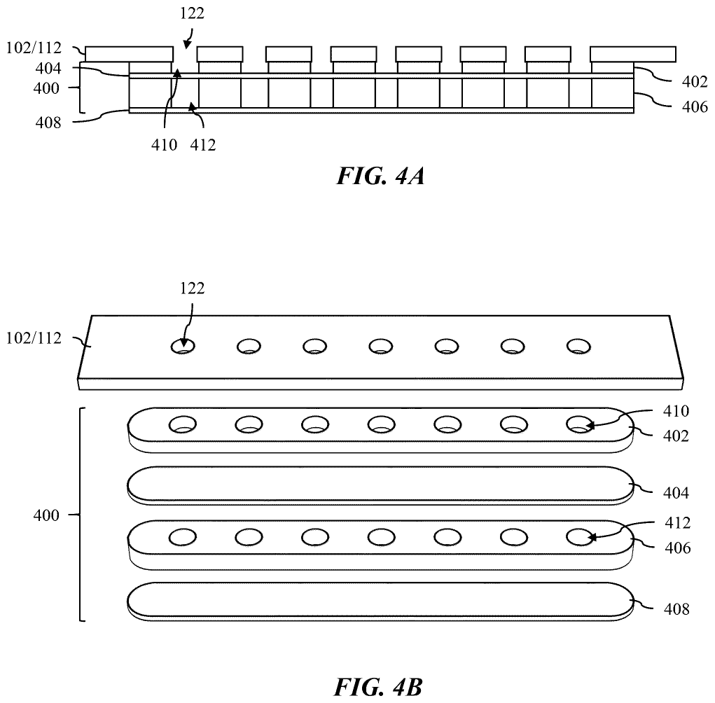

FIGS. 4A and 4B illustrate a cross-sectional view and an exploded view, respectively, of a speaker seal 400 that includes two adhesive layers 402, 406 and two mesh layers 404, 408. The adhesive layers 402, 406 and the mesh layers 404, 408 can be formed from any of the materials of the speaker seals 124, discussed above in reference to FIGS. 1B through 1D. The speaker seal 400 can be attached to a sidewall 112 of a housing 102. The speaker seal 400 can encircle, surround, or encompass a plurality of speaker openings 122 in the sidewall 112 (e.g., in a plan view of the speaker seal 400 and the sidewall 112). The adhesive layer 402 includes an opening 410 and the adhesive layer 406 includes an opening 412 for each of the speaker openings 122. The speaker seal 400 can be adhered to the sidewall 112 by the adhesive layer 402. The speaker seal 400 can be used to seal the speaker openings 122 of the housing 102 (e.g., from water, contaminants, and the like) while allowing sound to travel through the speaker openings 122.

As illustrated in FIGS. 4A and 4B, each of the adhesive layers 402, 406 and the mesh layers 404, 408 can have lengths and widths that extend past peripheries of the speaker openings 122. The peripheries of the adhesive layers 402, 406 and the mesh layers 404, 408 can encircle, surround, or encompass the peripheries of the speaker openings 122 (e.g., in a plan view of the speaker seal 400 and the sidewall 112). The adhesive layer 402 can be adhered to the sidewall 112 of the housing 102 such that the adhesive layer 402 encircles, surrounds, or encompasses each of the speaker openings 122. This ensures that any water or contaminants that enter the speaker openings 122 cannot bypass the speaker seal 400 and enter an internal volume of an electronic device that includes the housing 102. Although the adhesive layers 402, 406 and the mesh layers 404, 408 are illustrated as being capsule-shaped, the adhesive layers 402, 406 and the mesh layers 404, 408 can have any suitable shape, such as a rectangular shape, an oval shape, or the like.

In the example of FIGS. 4A and 4B, an opening 410 is provided in the adhesive layer 402 for each of the speaker openings 122 and an opening 412 is provided in the adhesive layer 406 for each of the speaker openings 122. The openings 410, 412 can have greater areas than the speaker openings 122. The openings 410, 412 and the speaker openings 122 can have circular shapes. As illustrated in FIGS. 4A and 4B, the openings 410, 412 can have greater diameters than the speaker openings 122; however, in some examples, the openings 410, 412 can have diameters equal to or less than diameters of the speaker openings 122. Each of the openings 410 and each of the openings 412 can be aligned with a respective speaker opening 122. Water and contaminants passing through the speaker openings 122 can be directed by the openings 410 to the mesh layer 404, and any water and contaminants that pass through the mesh layer 404 can be directed by the openings 412 to the mesh layer 408.

The mesh layer 404 can be formed from a mesh having a relatively low acoustic impedance and low ingress protection. The mesh layer 404 can be provided to break the flow of incoming water and contaminants and provide a pressure drop to the flow of incoming water and contaminants before the water and contaminants enter the openings 412. As such, the mesh layer 404 can be referred to as a pressure reduction mesh. The mesh layer 404 can be formed with a plain weave pattern or a twill weave pattern. The mesh layer 404 can be formed from filaments with diameters from about 30 μm to about 110 μm or from about 43 μm to about 105 μm. The mesh layer 404 can have openings with pore sizes from about 30 μm to about 110 μm or from about 34 μm to about 105 μm; an open area percentage from about 30% to about 65% or from about 32% to about 60%; and an acoustic impedance from about 10 Rayls to about 35 Rayls or from about 12 Rayls to about 30 Rayls. The mesh layer 404 can include a hydrophobic coating and can have a WCA from about 85° to about 140° or from about 90° to about 130°.

The mesh layer 408 can be formed from a mesh having a relatively high acoustic impedance and high ingress protection. The mesh layer 408 can be provided to prevent seepage through the speaker seal 400 and into an internal volume of an electronic device. As such, the mesh layer 408 can be referred to as a seepage reduction mesh. The mesh layer 408 can be formed with a twill weave pattern. In some examples, the mesh layer 408 can be formed with a plain weave pattern. The mesh layer 408 can be formed from filaments with diameters from about 35 μm to about 65 μm, from about 40 μm to about 60 μm, or from about 43 μm to about 58 μm. The mesh layer 408 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 408 can include a hydrophobic coating and can have a WCA from about 120° to about 150°, from about 120° to about 140°, or greater than about 130°. Thus, the mesh layer 408 can be formed from filaments with smaller diameters, greater filament density (e.g., smaller pore sizes and smaller open area percentages), higher acoustic impedance, and greater hydrophobicity relative to the mesh layer 404.

Because the pressure and flowrate of water and contaminants in the openings 412 adjacent to the mesh layer 408 are reduced, the mesh layer 408 can be formed from a mesh having a reduced acoustic impedance relative to an example in which the adhesive layer 402 and the mesh layer 404 are omitted. By including the two-layer structure of FIGS. 4A and 4B (including the two adhesive layers 402, 406 and the two mesh layers 404, 408), the speaker seal 400 can have improved ingress protection, while having a minimal acoustic impedance.

Sound waves propagating through the speaker seal 400 can cause the mesh layers 404, 408 to generate resonance and/or harmonics with one another. This can cause undesirable sound qualities in sound generated by the speakers of an electronic device. By providing the adhesive layer 406 with a thickness greater than a minimum thickness, harmonics and resonance between the mesh layers 404, 408 can be avoided. In some examples, the minimum thickness can be about 0.3 mm, about 0.4 mm, about 0.5 mm, or the like. The thickness of the adhesive layer 406 that can be included to avoid harmonics, and resonance can be dependent on the materials and properties of the mesh layers 404, 408. Acoustic properties of the adhesive layer 406 can also be altered to avoid harmonics and resonance within the speaker seal 400. For example, acoustic properties of the adhesive layer 406 can be altered to provide an ideal losses channel for acoustic waves to propagate or can be tuned to dampen undesired resonance through the speaker seal 400.

The speaker seal 400 can provide ingress protection of at least IPX2 or IPX4, while having a relatively low acoustic impedance. For example, the speaker seal 400 can have an acoustic impedance of less than about 150 Rayls, less than about 125 Rayls, less than about 110 Rayls, or less than about 105 Rayls. The speaker seal 400 can have thicknesses from about 0.5 mm to about 2.5 mm, from about 1 mm to about 2.25 mm, from about 1.25 mm to about 2 mm, or the like.

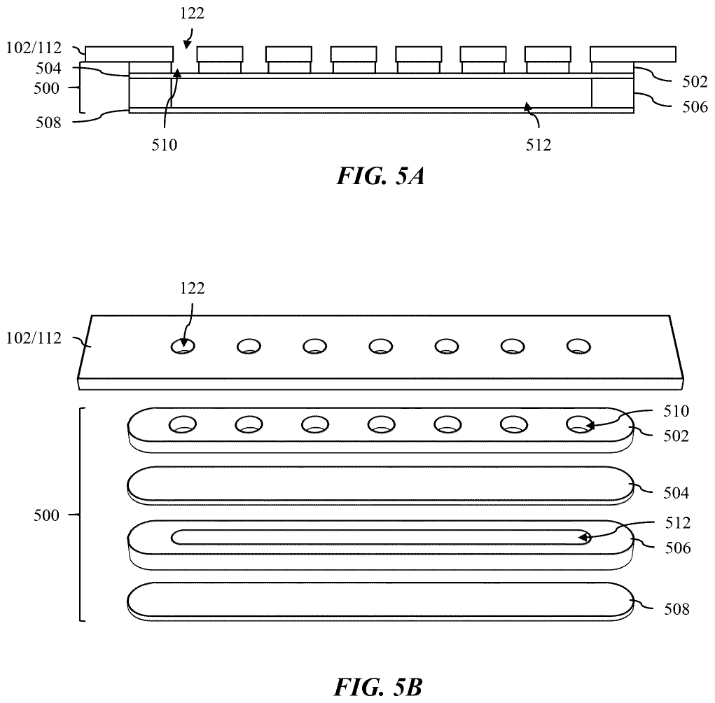

FIGS. 5A and 5B illustrate a cross-sectional view and an exploded view, respectively, of a speaker seal 500 that includes two adhesive layers 502, 506 and two mesh layers 504, 508. The adhesive layers 502, 506 and the mesh layers 504, 508 can be formed from any of the materials of the speaker seals 124, discussed above in reference to FIGS. 1B through 1D. The speaker seal 500 can be attached to a sidewall 112 of a housing 102. The speaker seal 500 can encircle, surround, or encompass a plurality of speaker openings 122 in the sidewall 112 (e.g., in a plan view of the speaker seal 500 and the sidewall 112). The adhesive layer 502 includes an opening 510 for each of the speaker openings 122 and the adhesive layer 506 includes an opening 512 for the plurality of speaker openings 122. The speaker seal 500 can be adhered to the sidewall 112 by the adhesive layer 502. The speaker seal 500 can be used to seal the speaker openings 122 of the housing 102 (e.g., from water, contaminants, and the like) while allowing sound to travel through the speaker openings 122.

As illustrated in FIGS. 5A and 5B, each of the adhesive layers 502, 506 and the mesh layers 504, 508 can have lengths and widths that extend past peripheries of the speaker openings 122. The peripheries of the adhesive layers 502, 506 and the mesh layers 504, 508 can encircle, surround, or encompass the peripheries of the speaker openings 122 (e.g., in a plan view of the speaker seal 500 and the sidewall 112). The adhesive layer 502 can be adhered to the sidewall 112 of the housing 102 such that the adhesive layer 502 encircles, surrounds, or encompasses each of the speaker openings 122. This ensures that any water or contaminants that enter the speaker openings 122 cannot bypass the speaker seal 500 and enter an internal volume of an electronic device that includes the housing 102. Although the adhesive layers 502, 506 and the mesh layers 504, 508 are illustrated as being capsule-shaped, the adhesive layers 502, 506 and the mesh layers 504, 508 can have any suitable shape, such as a rectangular shape, an oval shape, or the like.

In the example of FIGS. 5A and 5B, an opening 510 is provided in the adhesive layer 502 for each of the speaker openings 122 and a single opening 512 is provided in the adhesive layer 506 for the group of speaker openings 122. As illustrated in FIGS. 5A and 5B, the openings 510 can have greater diameters than the speaker openings 122; however, in some examples, the openings 510 can have diameters equal to or less than diameters of the speaker openings 122. Each of the openings 510 can be aligned with a respective speaker opening 122. The opening 512 can have a length equal to or greater than a length between a left edge of a leftmost speaker opening 122 and a right edge of a rightmost speaker opening 122. The opening 512 can have a width equal to or greater than a diameter of each of the speaker openings 122. The opening 512 can encircle, surround, or encompass the plurality of speaker openings 122 (e.g., in a plan view of the speaker seal 500 and the sidewall 112). The openings 510 and the speaker openings 122 can have circular shapes. The opening 512 can have a capsule-shape, as illustrated in FIGS. 5A and 5B, or any other suitable shape such as a rectangular shape, an oval shape, or the like.

Water and contaminants passing through the speaker openings 122 can be directed by the openings 510 to the mesh layer 504. Water and contaminants passing through the mesh layer 504 can be directed by the opening 512 to the mesh layer 508. By providing a single opening 512 that extends under multiple openings 510 (and speaker openings 122), water and contaminants that enter through one of the speaker openings 122 and openings 510 can pass through the opening 512 and be directed out of another of the openings 510 and speaker openings 122 without passing through the mesh layer 508. In other words, the opening 512 and the mesh layer 508 can redirect water and contaminants entering through a speaker opening 122 and an opening 510 out of another of the openings 510 and speaker openings 122. This allows for a mesh layer with a lower acoustic impedance and ingress protection rating to be used for the mesh layer 508, while still providing improved ingress protection, improving sound quality through the speaker seal 500.

In further detail, the opening 512 can create a flow channel within the adhesive layer 506. For example, when a pressurized flow of water and contaminants enters a leftmost speaker opening 122 and passes through a leftmost opening 510 and the mesh layer 504, a channel can be formed through the opening 512 out of the mesh layer 504, a rightmost opening 510, and a rightmost speaker opening 122. This channel can help water and contaminants to be flushed out of the speaker seal 500, reducing seepage through the mesh layer 508, and providing improved ingress protection within minimal acoustic impedance.

The mesh layer 504 can be formed from a mesh having a relatively low acoustic impedance and low ingress protection. The mesh layer 504 can be provided to break the flow of incoming water and contaminants and provide a pressure drop to the flow of incoming water and contaminants before the water and contaminants enter the opening 512. As such, the mesh layer 504 can be referred to as a pressure reduction mesh. The mesh layer 504 can be formed with a plain weave pattern or a twill weave pattern. The mesh layer 504 can be formed from filaments with diameters from about 30 μm to about 110 μm or from about 43 μm to about 105 μm. The mesh layer 504 can have openings with pore sizes from about 30 μm to about 110 μm or from about 34 μm to about 105 μm; an open area percentage from about 30% to about 65% or from about 32% to about 60%; and an acoustic impedance from about 10 Rayls to about 35 Rayls or from about 12 Rayls to about 30 Rayls. The mesh layer 504 can include a hydrophobic coating and can have a WCA from about 85° to about 140° or from about 90° to about 130°.

The mesh layer 508 can be formed from a mesh having a relatively high acoustic impedance and high ingress protection. The mesh layer 508 can be provided to prevent seepage through the speaker seal 500 and into an internal volume of an electronic device. As such, the mesh layer 508 can be referred to as a seepage reduction mesh. The mesh layer 508 can be formed with a twill weave pattern. In some examples, the mesh layer 508 can be formed with a plain weave pattern. The mesh layer 508 can be formed from filaments with diameters from about 35 μm to about 65 μm, from about 40 μm to about 60 μm, or from about 43 μm to about 58 μm. The mesh layer 508 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 508 can include a hydrophobic coating and can have a WCA from about 120° to about 150°, from about 120° to about 140°, or greater than about 130°. Thus, the mesh layer 508 can be formed from filaments with smaller diameters, greater filament density (e.g., smaller pore sizes and smaller open area percentages), higher acoustic impedance, and greater hydrophobicity relative to the mesh layer 504.

Because the pressure and flowrate of water and contaminants in the opening 512 adjacent to the mesh layer 508 are reduced, the mesh layer 508 can be formed from a mesh having a reduced acoustic impedance relative to an example in which the adhesive layer 502 and the mesh layer 504 are omitted. By including the two-layer structure of FIGS. 5A and 5B (including the two adhesive layers 502, 506 and the two mesh layers 504, 508), the speaker seal 500 can have improved ingress protection, while having a minimal acoustic impedance.

Sound waves propagating through the speaker seal 500 can cause the mesh layers 504, 508 to generate resonance and/or harmonics with one another. This can cause undesirable sound qualities in sound generated by the speakers of an electronic device. By providing the adhesive layer 506 with a thickness greater than a minimum thickness, harmonics and resonance between the mesh layers 504, 508 can be avoided. In some examples, the minimum thickness can be about 0.3 mm, about 0.4 mm, about 0.5 mm, or the like. The thickness of the adhesive layer 506 that can be included to avoid harmonics, and resonance can be dependent on the materials and properties of the mesh layers 504, 508. Acoustic properties of the adhesive layer 506 can also be altered to avoid harmonics and resonance within the speaker seal 500. For example, acoustic properties of the adhesive layer 506 can be altered to provide an ideal losses channel for acoustic waves to propagate or can be tuned to dampen undesired resonance through the speaker seal 500.

The speaker seal 500 can provide ingress protection of at least IPX2 or IPX4 water resistance rating, while having a relatively low acoustic impedance. For example, the speaker seal 500 can have an acoustic impedance of less than about 150 Rayls, less than about 125 Rayls, less than about 110 Rayls, or less than about 105 Rayls. The speaker seal 500 can have thicknesses from about 0.5 mm to about 2.5 mm, from about 1 mm to about 2.25 mm, from about 1.25 mm to about 2 mm, or the like.

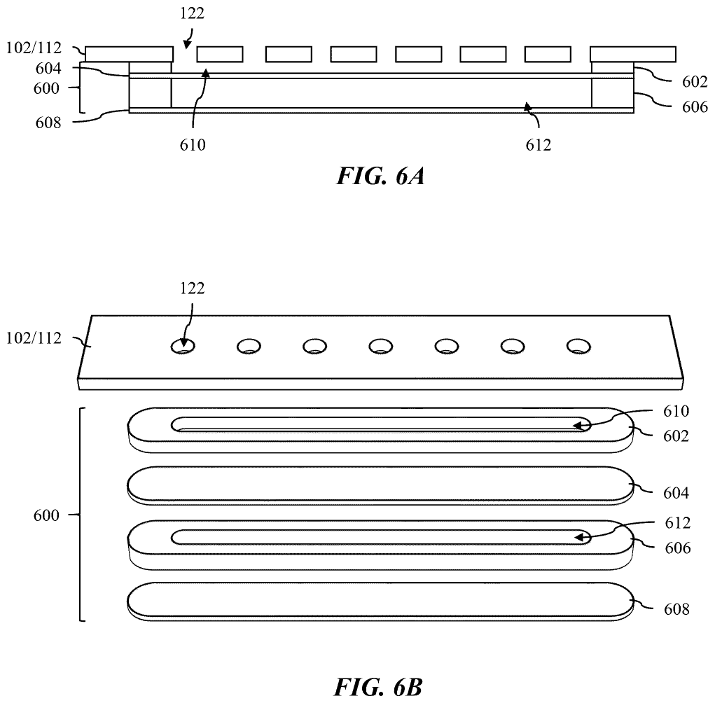

FIGS. 6A and 6B illustrate a cross-sectional view and an exploded view, respectively, of a speaker seal 600 that includes two adhesive layers 602, 606 and two mesh layers 604, 608. The adhesive layers 602, 606 and the mesh layers 604, 608 can be formed from any of the materials of the speaker seals 124, discussed above in reference to FIGS. 1B through 1D. The speaker seal 600 can be attached to a sidewall 112 of a housing 102. The speaker seal 600 can encircle, surround, or encompass a plurality of speaker openings 122 in the sidewall 112 (e.g., in a plan view of the speaker seal 600 and the sidewall 112). The adhesive layer 602 includes an orifice or opening 610 for the plurality of speaker openings 122 and the adhesive layer 606 includes an opening 612 for the plurality of speaker openings 122. The speaker seal 600 can be adhered to the sidewall 112 by the adhesive layer 602. The speaker seal 600 can be used to seal the speaker openings 122 of the housing 102 (e.g., from water, contaminants, and the like) while allowing sound to travel through the speaker openings 122.

As illustrated in FIGS. 6A and 6B, each of the adhesive layers 602, 606 and the mesh layers 604, 608 can have lengths and widths that extend past peripheries of the speaker openings 122. The peripheries of the adhesive layers 602, 606 and the mesh layers 604, 608 can encircle, surround, or encompass the peripheries of the speaker openings 122 (e.g., in a plan view of the speaker seal 600 and the sidewall 112). The adhesive layer 602 can be adhered to the sidewall 112 of the housing 102 such that the adhesive layer 602 encircles, surrounds, or encompasses each of the speaker openings 122. This ensures that any water or contaminants that enter the speaker openings 122 cannot bypass the speaker seal 600 and enter an internal volume of an electronic device that includes the housing 102. Although the adhesive layers 602, 606 and the mesh layers 604, 608 are illustrated as being capsule-shaped, the adhesive layers 602, 606 and the mesh layers 604, 608 can have any suitable shape, such as a rectangular shape, an oval shape, or the like.

In the example of FIGS. 6A and 6B, a single orifice or opening 610 is provided in the adhesive layer 602 for the group of speaker openings 122 and a single opening 612 is provided in the adhesive layer 606 for the group of speaker openings 122. The opening 610 can have a length equal to or greater than a length between a left edge of a leftmost speaker opening 122 and a right edge of a rightmost speaker opening 122. The opening 610 can have a width equal to or greater than a diameter of each of the speaker openings 122. The opening 610 can encircle, surround, or encompass the plurality of speaker openings 122 (e.g., in a plan view of the speaker seal 600 and the sidewall 112). The opening 612 can have a length equal to or greater than a length between a left edge of a leftmost speaker opening 122 and a right edge of a rightmost speaker opening 122. The opening 612 can have a width equal to or greater than a diameter of each of the speaker openings 122. The opening 612 can encircle, surround, or encompass the plurality of speaker openings 122 (e.g., in a plan view of the speaker seal 600 and the sidewall 112). The speaker openings 122 can have circular shapes. The openings 610, 612 can have capsule-shapes, as illustrated in FIGS. 6A and 6B, or any other suitable shapes such as rectangular shapes, oval shapes, or the like.

Water and contaminants passing through the speaker openings 122 can be directed by the opening 610 to the mesh layer 604. Water and contaminants passing through the mesh layer 604 can be directed by the opening 612 to the mesh layer 608. By providing a single opening 610 and a single opening 612 that extend under multiple speaker openings 122, water and contaminants that enter through one of the speaker openings 122 can pass through the openings 610, 612 and be directed out of others of the speaker openings 122 without passing through the mesh layer 604 or the mesh layer 608. In other words, the opening 610 and the mesh layer 604 can redirect water and contaminants entering through a speaker opening 122 out of another of the speaker openings 122. The opening 612 and the mesh layer 608 can also redirect water and contaminants entering through a speaker opening 122 out of another of the speaker openings 122 (by way of the mesh layer 604 and the opening 610). This allows for mesh layers with lower acoustic impedance and ingress protection ratings to be used for the mesh layers 604, 608, while still providing improved ingress protection, improving sound quality through the speaker seal 600.

In further detail, the openings 610, 612 can create flow channels within the adhesive layers 602, 606. For example, when a pressurized flow of water and contaminants enters a leftmost speaker opening 122, a channel can be formed through the opening 610 out of a rightmost speaker opening 122. Further, a channel can be formed through the opening 612 from the leftmost side to the rightmost side of the opening 612. These channels can help water and contaminants to be flushed out of the speaker seal 600, reducing seepage through the mesh layer 608, and providing improved ingress protection within minimal acoustic impedance.

In the example of FIGS. 6A and 6B, both the openings 610, 612 can be used to redirect ingress through the speaker openings 122. If the opening 612 included individual openings for each of the speaker openings 122, rather than the large connected opening 612, water and contaminants that enter the opening 612 could not be redirected and build up in pressure. This could allow for water to exit through the mesh layer 608 into an electronic device once a breakthrough pressure is reached. However, since the opening 612 includes a large interconnected reservoir, total pressure of static water that resides in the opening 612 is reduced, and ingress through the mesh layer 608 is prevented.

The mesh layer 604 can be formed from a mesh having a relatively low acoustic impedance and low ingress protection. The mesh layer 604 can be provided to break the flow of incoming water and contaminants and provide a pressure drop to the flow of incoming water and contaminants before the water and contaminants enter the opening 612. As such, the mesh layer 604 can be referred to as a pressure reduction mesh. The mesh layer 604 can be formed with a plain weave pattern or a twill weave pattern. The mesh layer 604 can be formed from filaments with diameters from about 30 μm to about 110 μm or from about 43 μm to about 105 μm. The mesh layer 604 can have openings with pore sizes from about 30 μm to about 110 μm or from about 34 μm to about 105 μm; an open area percentage from about 30% to about 65% or from about 32% to about 60%; and an acoustic impedance from about 10 Rayls to about 35 Rayls or from about 12 Rayls to about 30 Rayls. The mesh layer 604 can include a hydrophobic coating and can have a WCA from about 85° to about 140° or from about 90° to about 130°.

The mesh layer 608 can be formed from a mesh having a relatively high acoustic impedance and high ingress protection. The mesh layer 608 can be provided to prevent seepage through the speaker seal 600 and into an internal volume of an electronic device. As such, the mesh layer 608 can be referred to as a seepage reduction mesh. The mesh layer 608 can be formed with a twill weave pattern. In some examples, the mesh layer 608 can be formed with a plain weave pattern. The mesh layer 608 can be formed from filaments with diameters from about 35 μm to about 65 μm, from about 40 μm to about 60 μm, or from about 43 μm to about 58 μm. The mesh layer 608 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 608 can include a hydrophobic coating and can have a WCA from about 120° to about 150°, from about 120° to about 140°, or greater than about 130°. Thus, the mesh layer 608 can be formed from filaments with smaller diameters, greater filament density (e.g., smaller pore sizes and smaller open area percentages), higher acoustic impedance, and greater hydrophobicity relative to the mesh layer 604.

Because the pressure and flowrate of water and contaminants in the opening 612 adjacent to the mesh layer 608 are reduced, the mesh layer 608 can be formed from a mesh having a reduced acoustic impedance relative to an example in which the adhesive layer 602 and the mesh layer 604 are omitted. By including the two-layer structure of FIGS. 6A and 6B (including the two adhesive layers 602, 606 and the two mesh layers 604, 608), the speaker seal 600 can have improved ingress protection, while having a minimal acoustic impedance.

Sound waves propagating through the speaker seal 600 can cause the mesh layers 604, 608 to generate resonance and/or harmonics with one another. This can cause undesirable sound qualities in sound generated by the speakers of an electronic device. By providing the adhesive layer 606 with a thickness greater than a minimum thickness, harmonics and resonance between the mesh layers 604, 608 can be avoided. In some examples, the minimum thickness can be about 0.3 mm, about 0.4 mm, about 0.5 mm, or the like. The thickness of the adhesive layer 606 that can be included to avoid harmonics, and resonance can be dependent on the materials and properties of the mesh layers 604, 608. Acoustic properties of the adhesive layer 606 can also be altered to avoid harmonics and resonance within the speaker seal 600. For example, acoustic properties of the adhesive layer 606 can be altered to provide an ideal losses channel for acoustic waves to propagate or can be tuned to dampen undesired resonance through the speaker seal 600.

The speaker seal 600 can provide ingress protection of at least IPX2 or IPX4, while having a relatively low acoustic impedance. For example, the speaker seal 600 can have an acoustic impedance of less than about 150 Rayls, less than about 125 Rayls, less than about 110Rayls, or less than about 105 Rayls. The speaker seal 600 can have thicknesses from about 0.5 mm to about 2.5 mm, from about 1 mm to about 2.25 mm, from about 1.25 mm to about 2 mm, or the like.

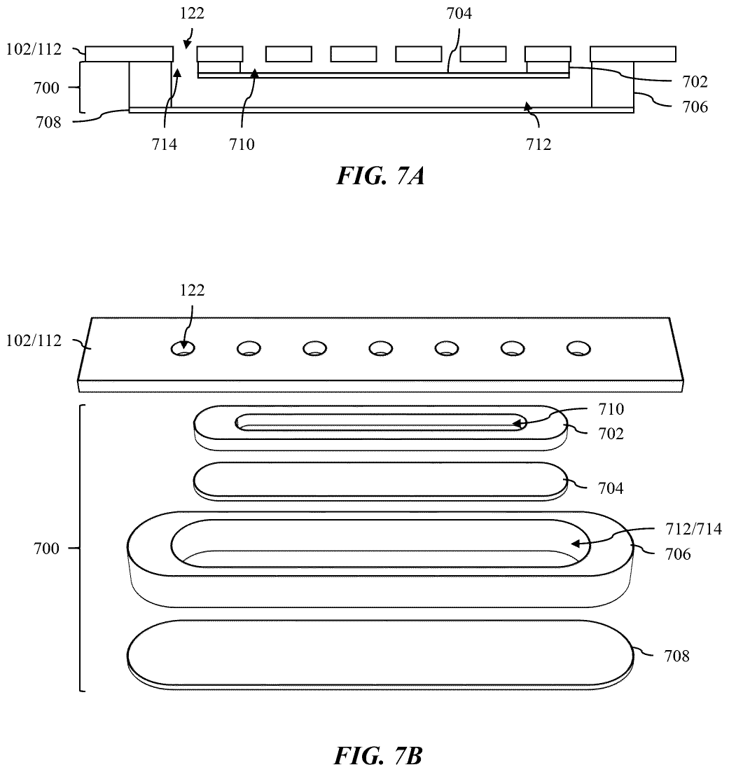

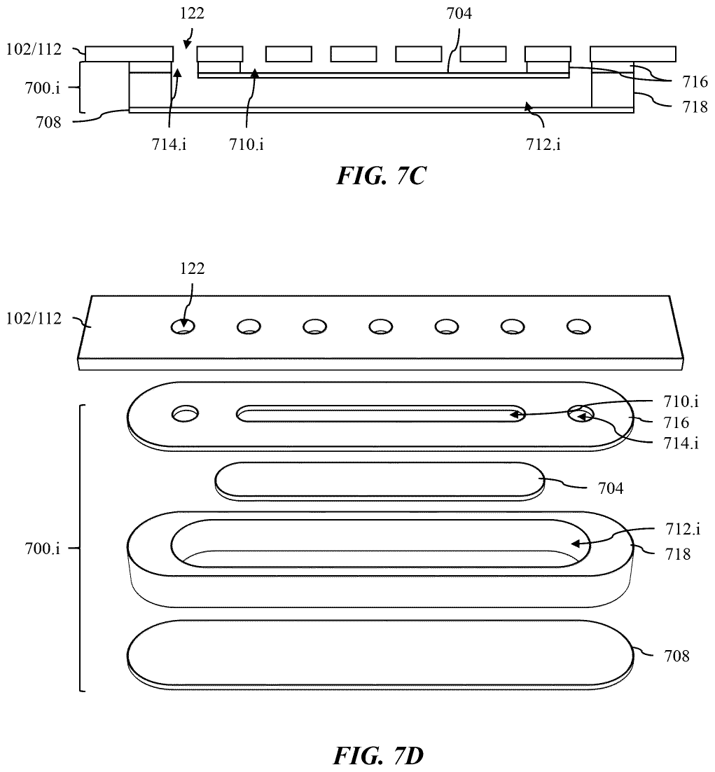

FIGS. 7A and 7B illustrate a cross-sectional view and an exploded view, respectively, of a speaker seal 700 that includes two adhesive layers 702, 706 and two mesh layers 704, 708. The adhesive layers 702, 706 and the mesh layers 704, 708 can be formed from any of the materials of the speaker seals 124, discussed above in reference to FIGS. 1B through 1D. The speaker seal 700 can be attached to a sidewall 112 of a housing 102. The speaker seal 700 can encircle, surround, or encompass a plurality of speaker openings 122 in the sidewall 112 (e.g., in a plan view of the speaker seal 700 and the sidewall 112). The adhesive layer 702 includes an orifice or opening 710 for a first subset of the speaker openings 122 and the adhesive layer 706 includes an orifice or opening 712 for a set of the speaker openings 122. The adhesive layer 706 can encircle, surround, or encompass the adhesive layer 702 and the mesh layer 704 such that the adhesive layer 702 and the mesh layer 704 are disposed in the opening 712 of the adhesive layer 706. An orifice or opening 714 can be formed between the adhesive layer 706 and the stacked adhesive layer 702 and mesh layer 704. The speaker seal 700 can be adhered to the sidewall 112 by the adhesive layer 702 and the adhesive layer 706. The speaker seal 700 can be used to seal the speaker openings 122 of the housing 102 (e.g., from water, contaminants, and the like) while allowing sound to travel through the speaker openings 122.

The first subset of the speaker openings 122 can include all of the speaker openings 122 except for an outermost speaker opening 122 at each end of the plurality of speaker openings 122. A second subset of the speaker openings 122 can include the outermost speaker opening 122 at each end of the plurality of speaker openings 122. The set of the speaker openings 122 can include the first and second subsets, or all of the speaker openings 122. In some examples, the first and second subsets of the speaker openings 122 can be different subsets of the speaker openings 122.

As illustrated in FIGS. 7A and 7B, the adhesive layer 702 and the mesh layer 704 can have lengths and widths that extend past peripheries of the first subset of the speaker openings 122. The peripheries of the adhesive layer 702 and the mesh layer 704 can encircle, surround, or encompass the peripheries of the first subset of the speaker openings 122 (e.g., in a plan view of the speaker seal 700 and the sidewall 112). The adhesive layer 702 can be adhered to the sidewall 112 of the housing 102 such that the adhesive layer 702 encircles, surrounds, or encompasses each of the speaker openings 122 in the first subset of the speaker openings 122.

The adhesive layer 706 and the mesh layer 708 can have lengths and widths that extend past peripheries of the set of the speaker openings 122. The peripheries of the adhesive layer 706 and the mesh layer 708 can encircle, surround, or encompass the peripheries of the set of the speaker openings 122 (e.g., in a plan view of the speaker seal 800 and the sidewall 112). The adhesive layer 706 can be adhered to the sidewall 112 of the housing 102 such that the adhesive layer 706 encircles, surrounds, or encompasses each of the speaker openings 122 in the set of the speaker openings 122. Providing the adhesive layer 702 and the adhesive layer 706 ensures that any water or contaminants that enter the speaker openings 122 cannot bypass the speaker seal 700 and enter an internal volume of an electronic device that includes the housing 102. Although the adhesive layers 702, 706 and the mesh layers 704, 708 are illustrated as being capsule-shaped, the adhesive layers 702, 706 and the mesh layers 704, 708 can have any suitable shape, such as a rectangular shape, an oval shape, or the like.

The opening 712 of the adhesive layer 706 can have a length and width equal to or greater than the lengths and widths of the adhesive layer 702 and the mesh layer 704. As such, the adhesive layer 706 can encircle, surround, or encompass sides of the adhesive layer 702 and the mesh layer 704 and the combination of the adhesive layer 706 and the mesh layer 708 can surround the adhesive layer 702 and the mesh layer 704. The length of the opening 712 can be greater than the lengths of the adhesive layer 702 and the mesh layer 704 such that openings 714 are formed between the adhesive layer 706 and each of the adhesive layer 702 and the mesh layer 704. The openings 714 can allow water and contaminants entering through the second subset of the speaker openings 122 to bypass the adhesive layer 702 and the mesh layer 704 and enter the opening 712 adjacent the mesh layer 708.

In the example of FIGS. 7A and 7B, a single opening 710 is provided in the adhesive layer 702 for the first subset of the speaker openings 122 and a single opening 712 is provided in the adhesive layer 706 for the set of the speaker openings 122. The opening 710 can have a length equal to or greater than a length between a left edge of a second to leftmost speaker opening 122 and a right edge of a second to rightmost speaker opening 122 (e.g., a leftmost speaker opening 122 and a rightmost speaker opening 122 in the first subset of the speaker openings 122). The opening 710 can have a width equal to or greater than a diameter of each of the speaker openings 122. The opening 710 can encircle, surround, or encompass the first subset of the speaker openings 122 (e.g., in a plan view of the speaker seal 700 and the sidewall 112). The opening 712 can have a length equal to or greater than a length between a left edge of a leftmost speaker opening 122 and a right edge of a rightmost speaker opening 122. The opening 712 can have a width equal to or greater than widths of the adhesive layer 702 and the mesh layer 704. The opening 712 can encircle, surround, or encompass the set of the speaker openings 122 (e.g., in a plan view of the speaker seal 700 and the sidewall 112). The speaker openings 122 can have circular shapes. The openings 710, 712 can have capsule-shapes, as illustrated in FIGS. 7A and 7B, or any other suitable shapes such as rectangular shapes, oval shapes, or the like.

Water and contaminants passing through the first subset of the speaker openings 122 can be directed by the opening 710 to the mesh layer 704. Water and contaminants passing through the second subset of the speaker openings 122 or passing through the mesh layer 704 can be directed by the opening 712 to the mesh layer 708. By providing a single opening 710 and a single opening 712 that extend under multiple speaker openings 122, water and contaminants that enter through one of the speaker openings 122 can pass through the openings 710, 712 and be directed out of others of the speaker openings 122 without passing through the mesh layer 704 or the mesh layer 708. In other words, the opening 710 and the mesh layer 704 can redirect water and contaminants entering through a speaker opening 122 out of another of the speaker openings 122. The opening 712 and the mesh layer 708 can also redirect water and contaminants entering through a speaker opening 122 out of another of the speaker openings 122. This allows for mesh layers with lower acoustic impedance and ingress protection ratings to be used for the mesh layers 704, 708, while still providing improved ingress protection, improving sound quality through the speaker seal 700.

In further detail, the opening 710 and the opening 712 can create flow channels within each of the adhesive layers 702, 706. For example, when a pressurized flow of water and contaminants enters a leftmost speaker opening 122, a channel can be formed through the opening 714, the opening 712, and the opening 714 out of a rightmost speaker opening 122. Similarly, when a pressurized flow of water and contaminants enters a leftmost speaker opening 122 in the first subset of the speaker openings 122, a channel can be formed through the opening 710 out of a rightmost speaker opening 122 in the first subset of the speaker openings 122. These channels can help water and contaminants to be flushed out of the speaker seal 700, reducing seepage through the mesh layer 708, and providing improved ingress protection within minimal acoustic impedance.

The mesh layer 704 can be formed from a mesh having a relatively low acoustic impedance and low ingress protection. The mesh layer 704 can be provided to break the flow of incoming water and contaminants and provide a pressure drop to the flow of incoming water and contaminants before the water and contaminants enter the opening 712. As such, the mesh layer 704 can be referred to as a pressure reduction mesh. The mesh layer 704 can be formed with a plain weave pattern or a twill weave pattern. The mesh layer 704 can be formed from filaments with diameters from about 30 μm to about 110 μm or from about 43 μm to about 105 μm. The mesh layer 704 can have openings with pore sizes from about 30 μm to about 110 μm or from about 34 μm to about 105 μm; an open area percentage from about 30% to about 65% or from about 32% to about 60%; and an acoustic impedance from about 10 Rayls to about 35 Rayls or from about 12 Rayls to about 30 Rayls. The mesh layer 704 can include a hydrophobic coating and can have a WCA from about 85° to about 140° or from about 90° to about 130°.

The mesh layer 708 can be formed from a mesh having a relatively high acoustic impedance and high ingress protection. The mesh layer 708 can be provided to prevent seepage through the speaker seal 700 and into an internal volume of an electronic device. As such, the mesh layer 708 can be referred to as a seepage reduction mesh. The mesh layer 708 can be formed with a twill weave pattern. In some examples, the mesh layer 708 can be formed with a plain weave pattern. The mesh layer 708 can be formed from filaments with diameters from about 35 μm to about 65 μm, from about 40 μm to about 60 μm, or from about 43 μm to about 58 μm. The mesh layer 708 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 708 can include a hydrophobic coating and can have a WCA from about 120° to about 150°, from about 120° to about 140°, or greater than about 130°. Thus, the mesh layer 708 can be formed from filaments with smaller diameters, greater filament density (e.g., smaller pore sizes and smaller open area percentages), higher acoustic impedance, and greater hydrophobicity relative to the mesh layer 704.

Because the pressure and flowrate of water and contaminants in the opening 712 adjacent to the mesh layer 708 are reduced, the mesh layer 708 can be formed from a mesh having a reduced acoustic impedance relative to an example in which the adhesive layer 702 and the mesh layer 704 are omitted. By including the two-layer structure of FIGS. 7A and 7B (including the two adhesive layers 702, 706 and the two mesh layers 704, 708), the speaker seal 700 can have improved ingress protection, while having a minimal acoustic impedance.

Portions of the mesh layer 708 can be directly exposed to the second subset of the speaker openings 122, without being protected by the mesh layer 704. These portions of the mesh layer 708 can be more likely to allow seepage through the mesh layer 708 due to direct exposure to pressurized flows of water and contaminants through the outer speaker openings 122. As such, in some examples, the portions of the mesh layer 708 directly under the outer speaker openings 122 can have larger filament diameters, tighter weaves (e.g., smaller pore sizes and smaller open area percentages), and higher acoustic impedance relative to areas of the mesh layer 708 that are not directly under the outer speaker openings 122. Providing varying characteristics in the mesh layer 708 can improve ingress protection of the mesh layer 708 without increasing or while minimally increasing the acoustic impedance of the mesh layer 708.

Sound waves propagating through the speaker seal 700 can cause the mesh layers 704, 708 to generate resonance and/or harmonics with one another. This can cause undesirable sound qualities in sound generated by the speakers of an electronic device. By providing the adhesive layer 706 with a thickness greater than a minimum thickness, harmonics and resonance between the mesh layers 704, 708 can be avoided. In some examples, the minimum thickness can be about 0.3 mm, about 0.4 mm, about 0.5 mm, or the like. The thickness of the adhesive layer 706 that can be included to avoid harmonics, and resonance can be dependent on the materials and properties of the mesh layers 704, 708. Acoustic properties of the adhesive layer 706 can also be altered to avoid harmonics and resonance within the speaker seal 700. For example, acoustic properties of the adhesive layer 706 can be altered to provide an ideal losses channel for acoustic waves to propagate or can be tuned to dampen undesired resonance through the speaker seal 700.

FIGS. 7C and 7D illustrate a cross-sectional view and an exploded view, respectively, of a speaker seal 700.i that is similar to the speaker seal 700 of FIGS. 7A and 7B except that the adhesive layers 702, 706 are replaced by adhesive layers 716, 718. The speaker seal 700.i includes two adhesive layers 716, 718 and two mesh layers 704, 708 (e.g., the same mesh layers 704, 708 as FIGS. 7A and 7B). The speaker seal 700.i can be attached to a sidewall 112 of a housing 102. The speaker seal 700.i can encircle, surround, or encompass a plurality of speaker openings 122 in the sidewall 112 (e.g., in a plan view of the speaker seal 700.i and the sidewall 112). The adhesive layer 716 includes an opening 710.i for a first subset of the speaker openings 122 and openings 714.i for a second subset of the speaker openings 122. The adhesive layer 718 includes an opening 712.i for a set of the speaker openings 122. The adhesive layer 718 can encircle, surround, or encompass the mesh layer 704 such that the mesh layer 704 is disposed in the opening 712.i of the adhesive layer 718. The speaker seal 700.i can be adhered to the sidewall 112 by the adhesive layer 716. The speaker seal 700.i can be used to seal the speaker openings 122 of the housing 102 (e.g., from water, contaminants, and the like) while allowing sound to travel through the speaker openings 122.

As illustrated in FIGS. 7C and 7D, the adhesive layer 716 can have a length and width that extends past peripheries of the speaker openings 122. The periphery of the adhesive layer 716 can encircle, surround, or encompass the peripheries of the set of speaker openings 122. The mesh layer 704 can have a length and width that extend past peripheries of the first subset of the speaker openings 122 (e.g., in a plan view of the speaker seal 700.i and the sidewall 112). The periphery of the mesh layer 704 can encircle, surround, or encompass the peripheries of the first subset of the speaker openings 122 (e.g., in a plan view of the speaker seal 700.i and the sidewall 112). The adhesive layer 718 and the mesh layer 708 can have lengths and widths that extend past peripheries of the set of the speaker openings 122. The peripheries of the adhesive layer 718 and the mesh layer 708 can encircle, surround, or encompass the peripheries of the set of the speaker openings 122 (e.g., in a plan view of the speaker seal 700.i and the sidewall 112). The adhesive layer 718 can be adhered to the adhesive layer 716 such that the adhesive layer 718 encircles, surrounds, or encompasses each of the speaker openings 122. Providing the adhesive layer 716 and the adhesive layer 718 ensures that any water or contaminants that enter the speaker openings 122 cannot bypass the speaker seal 700.i and enter an internal volume of an electronic device that includes the housing 102. Although the adhesive layers 716, 718 and the mesh layers 704, 708 are illustrated as being capsule-shaped, the adhesive layers 716, 718 and the mesh layers 704, 708 can have any suitable shape, such as a rectangular shape, an oval shape, or the like.

The opening 712.i of the adhesive layer 718 can have a length and width equal to or greater than the length and width of the mesh layer 704. As such, the adhesive layer 718 can encircle, surround, or encompass sides of the mesh layer 704 and the combination of the adhesive layer 718 and the mesh layer 708 can surround the mesh layer 704 (e.g., in a plan view of the speaker seal 700.i and the sidewall 112). The length of the opening 712.i can be greater than the length of the mesh layer 704 such that the opening 712.i encircles, surrounds, or encompasses the mesh layer 704. The openings 714.i in the adhesive layer 716 can be fluidly coupled to the opening 712.i. The openings 714.i can allow water and contaminants entering through the second set of the speaker openings 122 to bypass the mesh layer 704 and enter the opening 712.i adjacent the mesh layer 708.

In the example of FIGS. 7C and 7D, a single opening 710.i is provided in the adhesive layer 716 for the first subset of the speaker openings 122, two openings 714.i are provided in the adhesive layer 716 for the second subset of the speaker openings 122, and a single opening 712.i is provided in the adhesive layer 718 for the set of the speaker openings 122. The opening 710.i can have a length equal to or greater than a length between a left edge of a second to leftmost speaker opening 122 and a right edge of a second to rightmost speaker opening 122 (e.g., a leftmost speaker opening 122 and a rightmost speaker opening 122 in the first subset of the speaker openings 122). The opening 710.i can have a width equal to or greater than a diameter of each of the speaker openings 122. The opening 710.i can encircle, surround, or encompass the first subset of the speaker openings 122 (e.g., in a plan view of the speaker seal 700.i and the sidewall 112). The openings 714.i can have diameters greater than, equal to, or less than diameters of the speaker openings 122. Each of the openings 714.i can be aligned with a respective opening of the second subset of the speaker openings 122. The opening 712.i can have a length equal to or greater than a length between a left edge of a leftmost speaker opening 122 and a right edge of a rightmost speaker opening 122. The opening 712.i can have a width equal to or greater than the width of the mesh layer 704. The opening 712.i can encircle, surround, or encompass the set of the speaker openings 122 (e.g., in a plan view of the speaker seal 700.i and the sidewall 112). The speaker openings 122 and the openings 714.i can have circular shapes. The openings 710.i, 712.i can have capsule-shapes, as illustrated in FIGS. 7C and 7D, or any other suitable shapes such as rectangular shapes, oval shapes, or the like.

Water and contaminants passing through the first subset of the speaker openings 122 can be directed by the opening 710.i to the mesh layer 704. Water and contaminants passing through the second subset of the speaker openings 122 can be directed through the openings 714.i to the opening 712.i. Water and contaminants passing through the openings 714.i or passing through the mesh layer 704 can be directed by the opening 712.i to the mesh layer 708. By providing a single opening 710.i and a single opening 712.i that extend under multiple speaker openings 122, water and contaminants that enter through one of the speaker openings 122 can pass through the openings 710.i, 712.i and be directed out of others of the speaker openings 122 without passing through the mesh layer 704 or the mesh layer 708. In other words, the opening 710.i and the mesh layer 704 can redirect water and contaminants entering through a speaker opening 122 out of another of the speaker openings 122. The opening 712.i and the mesh layer 708 can also redirect water and contaminants entering through a speaker opening 122 out of another of the speaker openings 122. This allows for mesh layers with lower acoustic impedance and ingress protection ratings to be used for the mesh layers 704, 708, while still providing improved ingress protection, improving sound quality through the speaker seal 700.i.

In further detail, the openings 710.i, 712.i, 714.i can create flow channels within each of the adhesive layers 716, 718. For example, when a pressurized flow of water and contaminants enters a leftmost speaker opening 122, a channel can be formed through the left opening 714.i, the opening 712.i, and the right opening 714.i out of a rightmost speaker opening 122. Similarly, when a pressurized flow of water and contaminants enters a leftmost speaker opening 122 in the first subset of the speaker openings 122, a channel can be formed through the opening 710.i out of a rightmost speaker opening 122 in the first subset of the speaker openings 122. These channels can help water and contaminants to be flushed out of the speaker seal 700, reducing seepage through the mesh layer 708, and providing improved ingress protection within minimal acoustic impedance.

The speaker seals 700, 700.i can provide ingress protection of at least IPX2 or IPX4, while having a relatively low acoustic impedance. For example, the speaker seals 700, 700.i can have an acoustic impedance of less than about 100 Rayls, less than about 90 Rayls, less than about 80 Rayls, less than about 70 Rayls, less than about 65 Rayls, less than about 60 Rayls, or less than about 55 Rayls. The speaker seals 700, 700.i can have thicknesses from about 0.5 mm to about 2 mm, from about 0.75 mm to about 1.75 mm, from about 1 mm to about 1.5 mm, or the like.

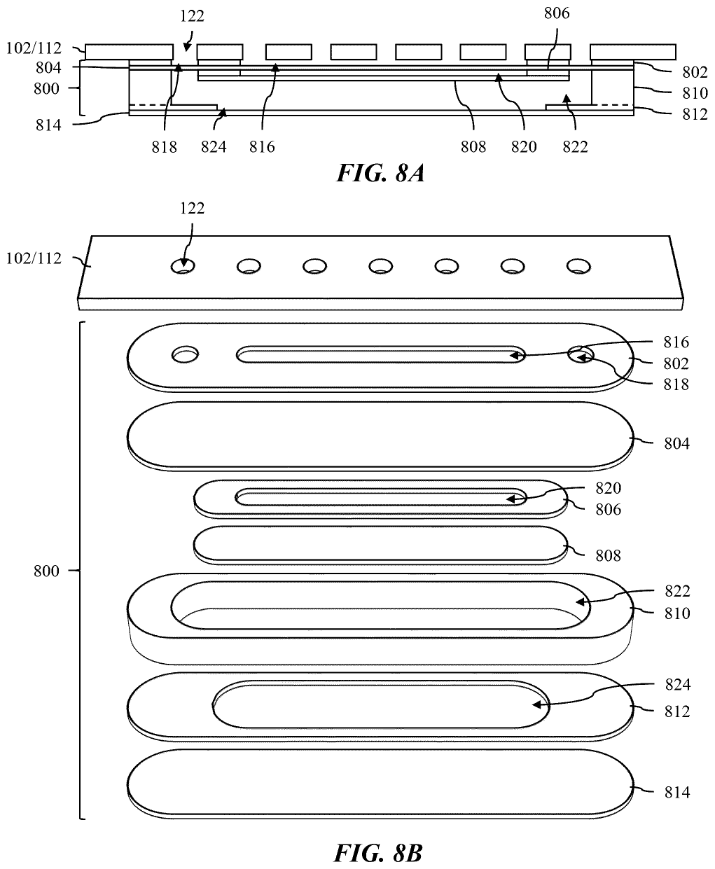

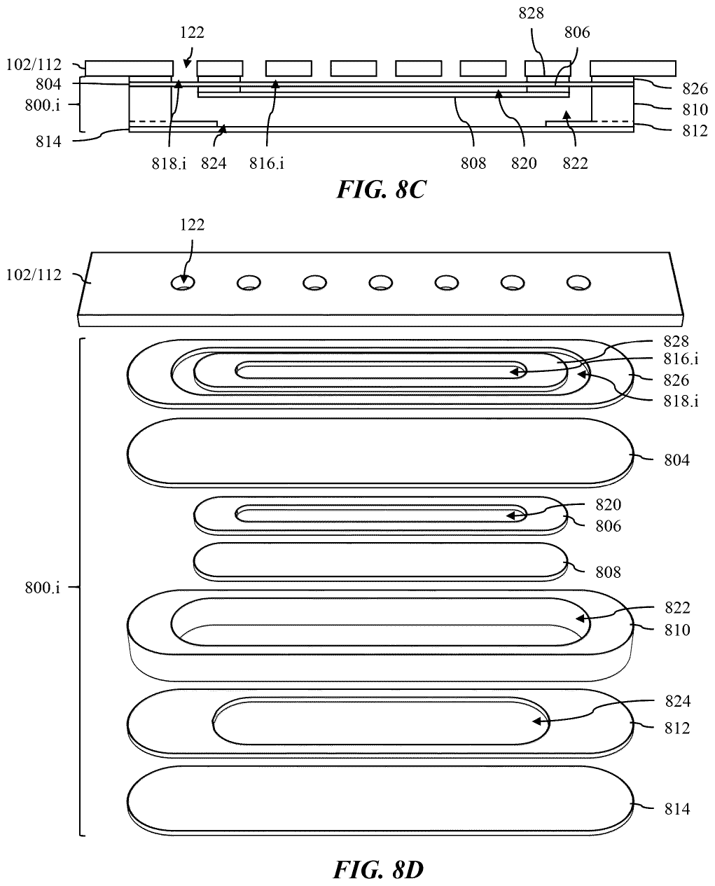

FIGS. 8A and 8B illustrate a cross-sectional view and an exploded view, respectively, of a speaker seal 800 that includes four adhesive layers 802, 806, 810, 812 and three mesh layers 804, 808, 814. The adhesive layers 802, 806, 810, 812 and the mesh layers 804, 808, 814 can be formed from any of the materials of the speaker seals 124, discussed above in reference to FIGS. 1B through 1D. The speaker seal 800 can be attached to a sidewall 112 of a housing 102. The speaker seal 800 can encircle, surround, or encompass a plurality of speaker openings 122 in the sidewall 112 (e.g., in a plan view of the speaker seal 800 and the sidewall 112). The adhesive layer 802 includes an opening 816 for a fist subset of the speaker openings 122 and openings 818 for a second subset of the speaker openings 122. The adhesive layer 806 includes an opening 820 for the first subset of the speaker openings 122. The adhesive layer 810 includes an orifice or opening 822 for a set of the speaker openings 122. The adhesive layer 812 includes an orifice or opening 824 for redirecting a flow of water or contaminants. The adhesive layer 810 can encircle, surround, or encompass the adhesive layer 806 and the mesh layer 808 such that the adhesive layer 806 and the mesh layer 808 are disposed in the opening 822 of the adhesive layer 810. The speaker seal 800 can be adhered to the sidewall 112 by the adhesive layer 802. The speaker seal 800 can be used to seal the speaker openings 122 of the housing 102 (e.g., from water, contaminants, and the like) while allowing sound to travel through the speaker openings 122.

The first subset of the speaker openings 122 can include all of the speaker openings 122 except for an outermost speaker opening 122 at each end of the plurality of speaker openings 122. A second subset of the speaker openings 122 can include the outermost speaker opening 122 at each end of the plurality of speaker openings 122. The set of the speaker openings 122 can include the first and second subsets, or all of the speaker openings 122. In some examples, the first and second subsets of the speaker openings 122 can be different subsets of the speaker openings 122.

As illustrated in FIGS. 8A and 8B, the adhesive layer 802 and the mesh layer 804 can have lengths and widths that extend past peripheries of the set of the speaker openings 122. The adhesive layer 802 can be adhered to the sidewall 112 of the housing 102 and the mesh layer 804 can be adhered to the adhesive layer 802 such that the adhesive layer 802 and the mesh layer 804 encircle, surround, or encompass each of the speaker openings 122 in the set of the speaker openings 122 (e.g., in a plan view of the speaker seal 800 and the sidewall 112). The adhesive 802 can be included to provide cosmetic uniformity to the mesh layer 804. In some examples, the adhesive layer 802 can include individual openings for each of the speaker openings 122. Providing openings in the adhesive layer 802 for each of the speaker openings 122 can reduce waviness and wrinkles in the mesh layer 804 and can help to reduce resonance within the speaker seal 800.

The adhesive layer 806 and the mesh layer 808 can have lengths and widths that extend past peripheries of the first subset of the speaker openings 122. The peripheries of the adhesive layer 806 and the mesh layer 808 can encircle, surround, or encompass the peripheries of the first subset of the speaker openings 122 (e.g., in a plan view of the speaker seal 800 and the sidewall 112). The adhesive layer 806 and the mesh layer 808 can have lengths that extend within inner edges of the speaker openings 122 of the second subset of the speaker openings 122. The adhesive layer 806 can be adhered to the mesh layer 804 and the mesh layer 808 can be adhered to the adhesive layer 806 such that the adhesive layer 806 and the mesh layer 808 encircle, surround, or encompass each of the speaker openings 122 in the first subset of the speaker openings 122.

The adhesive layers 810, 812 and the mesh layer 814 can have lengths and widths that extend past peripheries of the set of the speaker openings 122. The peripheries of the adhesive layers 810, 812 and the mesh layer 814 can encircle, surround, or encompass the peripheries of the set of the speaker openings 122 (e.g., in a plan view of the speaker seal 800 and the sidewall 112). The adhesive layer 810 can be adhered to the mesh layer 804 and the adhesive layer 812 can be adhered to the adhesive layer 810 such that the adhesive layers 810, 812 and the mesh layer 814 encircles, surrounds, or encompasses each of the speaker openings 122 in the set of the speaker openings 122. In some examples, the adhesive layer 810 and the adhesive layer 812 can be a single, integral adhesive layer. In such examples, the adhesive layer 812 can be referred to as a protrusion or flange of the adhesive layer 810. The adhesive layer 812 can cover at least a portion of the mesh layer 814, we can redirect water and contaminants projected towards the mesh layer 814. Providing the adhesive layers 802, 806, 810, 812 ensures that any water or contaminants that enter the speaker openings 122 cannot bypass the speaker seal 800 and enter an internal volume of an electronic device that includes the housing 102 without passing through the mesh layers 804, 808, 814. Although the adhesive layers 802, 806, 810, 812 and the mesh layers 804, 808, 814 are illustrated as being capsule-shaped, the adhesive layers 802, 806, 810, 812 and the mesh layers 804, 808, 814 can have any suitable shape, such as a rectangular shape, an oval shape, or the like.

In some examples, the adhesive layer 812 can be a redirection layer that is not adhesive. For example, the adhesive layer 812 can be replaced by a thin film layer or the like that does not extend to an edge of the adhesive layer 810. In such examples, the thin film layer replacing the adhesive layer 812 and the mesh layer 814 can both be adhered to the adhesive layer 810, which can retain the thin film layer replacing the adhesive layer 812 and the mesh layer 814 in desired positions within the speaker seal 800.

The opening 822 of the adhesive layer 810 can have a length and width equal to or greater than the lengths and widths of the adhesive layer 806 and the mesh layer 808. As such, the adhesive layer 810 can encircle, surround, or encompass sides of the adhesive layer 806 and the mesh layer 808 and the combination of the adhesive layers 810, 812 and the mesh layer 814 can surround the adhesive layer 806 and the mesh layer 808 (e.g., in a plan view of the speaker seal 800 and the sidewall 112). The length of the opening 822 can be greater than the lengths of the adhesive layer 806 and the mesh layer 808 such that openings are formed between the adhesive layer 810 and each of the adhesive layer 806 and the mesh layer 808. The openings can allow water and contaminants entering through the second subset of the speaker openings 122 to bypass the adhesive layer 806 and the mesh layer 808 and enter the openings 822, 824 adjacent the mesh layer 814.

In the example of FIGS. 8A and 8B, a single opening 816 is provided in the adhesive layer 802 for the first subset of the speaker openings 122, two openings 818 are provided in the adhesive layer 802 for the second subset of the speaker openings 122, a single orifice or opening 820 is provided in the adhesive layer 806 for the first subset of the speaker openings 122, a single opening 822 is provided in the adhesive layer 810 for the set of the speaker openings 122, and a single opening 824 is provided in the adhesive layer 812 for the first subset of the speaker openings 122. The orifices or openings 816, 820 can have lengths equal to or greater than a length between a left edge of a second to leftmost speaker opening 122 and a right edge of a second to rightmost speaker opening 122 (e.g., a leftmost speaker opening 122 and a rightmost speaker opening 122 in the first subset of the speaker openings 122). The lengths of the openings 816, 820 can be less than a length between a right edge of a leftmost speaker opening 122 and a left edge of a rightmost speaker opening 122. The openings 816, 820 can have widths equal to or greater than a diameter of each of the speaker openings 122. The openings 816, 820 can encircle, surround, or encompass the first subset of the speaker openings 122 (e.g., in a plan view of the speaker seal 800 and the sidewall 112). The openings 818 can have diameters greater than, equal to, or less than diameters of the speaker openings 122. Each of the openings 818 can be aligned with a respective opening of the second subset of the speaker openings 122. The opening 822 can have a length equal to or greater than a length between a left edge of a leftmost speaker opening 122 and a right edge of a rightmost speaker opening 122. The opening 822 can have a width equal to or greater than the widths of the adhesive layer 806 and the mesh layer 808. The opening 822 can encircle, surround, or encompass the set of the speaker openings 122 (e.g., in a plan view of the speaker seal 800 and the sidewall 112). The opening 824 can have a length less than or equal to the length between a right edge of a leftmost speaker opening 122 and a left edge of a rightmost speaker opening 122. The opening 824 can encircle, surround, or encompass the first subset of the speaker openings 122 (e.g., in a plan view of the speaker seal 800 and the sidewall 112). The speaker openings 122 and the openings 818 can have circular shapes. The openings 816, 820, 822, 824 can have capsule-shapes, as illustrated in FIGS. 8A and 8B, or any other suitable shapes such as rectangular shapes, oval shapes, or the like.

Water and contaminants passing through the first subset of the speaker openings 122 can be directed by the opening 816 to the mesh layer 804. Water and contaminants passing through the opening 816 and the mesh layer 804 can be directed by the opening 820 to the mesh layer 808. Water and contaminants passing through the second subset of the speaker openings 122 can be directed by the openings 818 to the mesh layer 804. Water and contaminants passing through the mesh layer 804 outside the stacked adhesive layer 806 and mesh layer 808 or passing through the mesh layer 808 can be directed by the openings 822, 824 to the mesh layer 814. By providing single openings 816, 820, 822, 824 that extend under multiple speaker openings 122, water and contaminants that enter through one of the speaker openings 122 can pass through the openings 816, 820, 822, 824 and be directed out of others of the speaker openings 122 without passing through the mesh layers 804, 808, 814. In other words, the opening 816 and the mesh layer 804 can redirect water and contaminants entering through a speaker opening 122 out of another of the speaker openings 122. The opening 820 and the mesh layer 808 can redirect water and contaminants entering through a speaker opening 122 out of another of the speaker openings 122 (by way of the opening 816 and the mesh layer 804). The openings 822, 824 and the mesh layer 814 can redirect water and contaminants entering through a speaker opening 122 out of another of the speaker openings 122 (by way of any of the openings 818, 816, 820 and the mesh layers 804, 808). This allows for mesh layers with lower acoustic impedance and ingress protection ratings to be used for the mesh layers 804, 808, 814, while still providing improved ingress protection, improving sound quality through the speaker seal 800.

Water and contaminants that pass through the second set of the speaker openings 122 and the mesh layer 804 can be pressurized (e.g., have a sufficient velocity) such that the water and contaminants can pass through the mesh layer 814. The adhesive layer 812, which has a smaller opening 824 relative to the opening 822 of the adhesive layer 810 can block this direct flow, provide a pressure reduction, and redirect water and contaminants. This improves ingress protection of the speaker seal 800 and allows for a mesh layer with reduces acoustic impedance to be used for the mesh layer 814.

In further detail, the openings 816, 818, 820, 822, 824 can create flow channels within each of the adhesive layers 802, 806, 810, 812. For example, when a pressurized flow of water and contaminants enters a leftmost speaker opening 122, a channel can be formed through the left opening 818, the openings 822, 824, and the right opening 818 out of a rightmost speaker opening 122. Similarly, when a pressurized flow of water and contaminants enters a leftmost speaker opening 122 in the first subset of the speaker openings 122, a channel can be formed through the opening 816 out of a rightmost speaker opening 122 in the first subset of the speaker openings 122. The pressurized flow of water and contaminants entering the leftmost speaker opening 122 in the first subset of the speaker openings 122, can form a channel in the opening 820 that extends out of the rightmost speaker opening 122 in the first subset of the speaker openings 122. These channels can help water and contaminants to be flushed out of the speaker seal 800, reducing seepage through the mesh layer 814, and providing improved ingress protection within minimal acoustic impedance.

The mesh layer 804 can be formed from a mesh having a relatively low acoustic impedance and low ingress protection. The mesh layer 804 can be included to provide a uniform appearance through each of the speaker openings 122, improving the aesthetics of the speaker seal 800 through the speaker openings 122. As such, the mesh layer 804 can be referred to as a cosmetic mesh. The mesh layer 804 can further be provided to break the flow of incoming water and contaminants and provide a pressure drop to the flow of incoming water and contaminants before the water and contaminants enter the openings 820, 822. The mesh layer 804 can be formed with a plain weave pattern or a twill weave pattern. The mesh layer 804 can be formed from filaments with diameters from about 40 μm to about 260 μm or from about 45 μm to about 255 μm. The mesh layer 804 can have openings with pore sizes from about 40 μm to about 300 μm or from about 50 μm to about 285 μm; an open area percentage from about 30% to about 65% or from about 33% to about 60%; and an acoustic impedance from about 2 Rayls to about 20 Rayls or from about 3 Rayls to about 15 Rayls. The mesh layer 804 can include a hydrophobic coating and can have a WCA from about 85° to about 140° or from about 90° to about 130°.

The mesh layer 810 can be formed from a mesh having a relatively low acoustic impedance and low ingress protection. The mesh layer 810 can be provided to break the flow of incoming water and contaminants and provide a pressure drop to the flow of incoming water and contaminants before the water and contaminants enter the opening 822. As such, the mesh layer 810 can be referred to as a pressure reduction mesh. The mesh layer 810 can be formed with a plain weave pattern or a twill weave pattern. The mesh layer 810 can be formed from filaments with diameters from about 30 μm to about 110 μm or from about 43 μm to about 105 μm. The mesh layer 810 can have openings with pore sizes from about 30 μm to about 110 μm or from about 34 μm to about 105 μm; an open area percentage from about 30% to about 65% or from about 32% to about 60%; and an acoustic impedance from about 10 Rayls to about 35 Rayls or from about 12 Rayls to about 30 Rayls. The mesh layer 810 can include a hydrophobic coating and can have a WCA from about 85° to about 140° or from about 90° to about 130°.

The mesh layer 814 can be formed from a mesh having a relatively high acoustic impedance and high ingress protection. The mesh layer 814 can be provided to prevent seepage through the speaker seal 800 and into an internal volume of an electronic device. As such, the mesh layer 814 can be referred to as a seepage reduction mesh. The mesh layer 814 can be formed with a twill weave pattern. In some examples, the mesh layer 814 can be formed with a plain weave pattern. The mesh layer 814 can be formed from filaments with diameters from about 35 μm to about 65 μm, from about 40 μm to about 60 μm, or from about 43 μm to about 58 μm. The mesh layer 814 can have openings with pore sizes from about 15 μm to about 40 μm or from about 18 μm to about 34 μm; an open area percentage from about 15% to about 35% or from about 18% to about 32%; and an acoustic impedance from about 25 Rayls to about 160 Rayls or from about 30 Rayls to about 155 Rayls. The mesh layer 814 can include a hydrophobic coating and can have a WCA from about 120° to about 150°, from about 120° to about 140°, or greater than about 130°. Thus, the mesh layer 814 can be formed from filaments with smaller diameters, greater filament density (e.g., smaller pore sizes and smaller open area percentages), higher acoustic impedance, and greater hydrophobicity relative to the mesh layers 804, 810.

Because the pressure and flowrate of water and contaminants in the openings 822, 824 adjacent to the mesh layer 814 are reduced, the mesh layer 814 can be formed from a mesh having a reduced acoustic impedance relative to an example in which the adhesive layers 802, 806 and the mesh layers 804, 808 are omitted. By including the multi-layer structure of FIGS. 8A and 8B (including the four adhesive layers 802, 806, 810, 812 and the three mesh layers 804, 808, 814), the speaker seal 800 can have improved ingress protection, while having a minimal acoustic impedance.

Sound waves propagating through the speaker seal 800 can cause the mesh layers 804, 808, 814 to generate resonance and/or harmonics with one another. This can cause undesirable sound qualities in sound generated by the speakers of an electronic device. By providing the adhesive layers 802, 806, 822, 824 with thicknesses greater than a minimum thickness, harmonics and resonance between the mesh layers 804, 808, 814 can be avoided. In some examples, the minimum thickness can be about 0.3 mm, about 0.4 mm, about 0.5 mm, or the like. The thickness of the adhesive layers 802, 806, 822, 824 that can be included to avoid harmonics, and resonance can be dependent on the materials and properties of the mesh layers 804, 808, 814. For example, the mesh layer 804 can have a sufficiently low acoustic impedance that the mesh layer 804 does not resonate, and a lower minimum thickness can be used for the adhesive layers 802, 806. Acoustic properties of the adhesive layers 802, 806, 822, 824 can also be altered to avoid harmonics and resonance within the speaker seal 800. For example, acoustic properties of the adhesive layers 802, 806, 822, 824 can be altered to provide an ideal losses channel for acoustic waves to propagate or can be tuned to dampen undesired resonance through the speaker seal 800.

FIGS. 8C and 8D illustrate a cross-sectional view and an exploded view, respectively, of a speaker seal 800.i that is similar to the speaker seal 800 of FIGS. 8A and 8B except that the adhesive layer 802 is replaced by adhesive layers 826, 828. The speaker seal 800.i includes five adhesive layers 826, 828, 806, 810, 812 and three mesh layers 804, 808, 814 (e.g., the same mesh layers 804, 808, 814 as FIGS. 8A and 8B). The speaker seal 800.i can be attached to a sidewall 112 of a housing 102. The speaker seal 800.i can encircle, surround, or encompass a plurality of speaker openings 122 in the sidewall 112 (e.g., in a plan view of the speaker seal 800.i and the sidewall 112). The adhesive layer 828 includes an orifice or opening 816.i for a fist subset of the speaker openings 122. The adhesive layer 826 includes openings 818.i for a second subset of the speaker openings 122. The speaker seal 800 can be adhered to the sidewall 112 by the adhesive layers 826, 828. The speaker seal 800 can be used to seal the speaker openings 122 of the housing 102 (e.g., from water, contaminants, and the like) while allowing sound to travel through the speaker openings 122.

As illustrated in FIGS. 8C and 8D, the adhesive layer 826 can have a length and a width that extend past peripheries of the set of the speaker openings 122. The adhesive layer 826 can be adhered to the sidewall 112 of the housing 102 and the mesh layer 804 can be adhered to the adhesive layer 828 such that the adhesive layer 826 and the mesh layer 804 encircle, surround, or encompass each of the speaker openings 122 in the set of the speaker openings 122 (e.g., in a plan view of the speaker seal 800.i and the sidewall 112). The adhesive layer 828 can have a length and a width that extend past peripheries of the first subset of the speaker openings 122. The periphery of the adhesive layer 828 can encircle, surround, or encompass the peripheries of the first subset of the speaker openings 122 (e.g., in a plan view of the speaker seal 800.i and the sidewall 112). The adhesive layer 828 can have a length that extends within inner edges of the speaker openings 122 of the second subset of the speaker openings 122. The adhesive layer 828 can be adhered to the sidewall 112 of the housing 102 and the mesh layer 804 can be adhered to the adhesive layer 828. The adhesive layer 828 can encircle, surround, or encompass each of the speaker openings 122 in the first subset of the speaker openings 122.

In the example of FIGS. 8C and 8D, a single opening 816.i is provided in the adhesive layer 828 for the first subset of the speaker openings 122 and a single opening 818.i is provided in the adhesive layer 826 for the second subset of the speaker openings 122. The opening 816.i can have a length equal to or greater than a length between a left edge of a second to leftmost speaker opening 122 and a right edge of a second to rightmost speaker opening 122 (e.g., a leftmost speaker opening 122 and a rightmost speaker opening 122 in the first subset of the speaker openings 122). The length of the opening 816.i can be less than a length between a right edge of a leftmost speaker opening 122 and a left edge of a rightmost speaker opening 122. The opening 816.i can have a width equal to or greater than a diameter of each of the speaker openings 122. The opening 816.i can encircle, surround, or encompass the first subset of the speaker openings 122 (e.g., in a plan view of the speaker seal 800 and the sidewall 112). The opening 818.i can have a length equal to or greater than a length between a left edge of a leftmost speaker opening 122 and a right edge of a rightmost speaker opening 122. The opening 818.i can have a width equal to or greater than the width of the adhesive layer 828. The opening 818.i can encircle, surround, or encompass the set of the speaker openings 122 (e.g., in a plan view of the speaker seal 800 and the sidewall 112). The openings 816.i, 818.i can have capsule-shapes, as illustrated in FIGS. 8C and 8D, or any other suitable shapes such as rectangular shapes, oval shapes, or the like. The openings 816.i and 818.i can function in the same way as the openings 816, 818.

The speaker seals 800, 800.i can provide ingress protection of at least IPX2 or IPX4, while having a relatively low acoustic impedance. For example, the speaker seals 800, 800.i can have an acoustic impedance of less than about 100 Rayls, less than about 90 Rayls, less than about 80 Rayls, less than about 70 Rayls, less than about 65 Rayls, or less than about 60 Rayls. The speaker seals 800, 800.i can have thicknesses from about 0.5 mm to about 2 mm, from about 0.75 mm to about 1.75 mm, from about 1 mm to about 1.5 mm, or the like.

To the extent applicable to the present technology, gathering and use of data available from various sources can be used to improve the delivery to users of invitational content or any other content that can be of interest to them. The present disclosure contemplates that in some instances, this gathered data can include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

As used herein, the terms exterior, outer, interior, inner, top, and bottom are used for reference purposes only. An exterior or outer portion of a component can form a portion of an exterior surface of the component but may not necessarily form the entire exterior of outer surface thereof. Similarly, the interior or inner portion of a component can form or define an interior or inner portion of the component but can also form or define a portion of an exterior or outer surface of the component. A top portion of a component can be located above a bottom portion in some orientations of the component, but can also be located in line with, below, or in other spatial relationships with the bottom portion depending on the orientation of the component.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including: ” and “having” come as used in the specification and claims shall have the same meaning as the term “comprising.”

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An electronic device comprising:
a housing sidewall defining a first opening and a second opening;
an electronic positioned adjacent to the housing sidewall; and
a seal disposed between the electronic and the housing sidewall, the seal comprising:
a first adhesive layer engaging the housing sidewall;
a first mesh layer on the first adhesive layer opposite the housing sidewall;
a second adhesive layer on the first mesh layer opposite the first adhesive layer; and
a second mesh layer on the second adhesive layer opposite the first mesh layer, wherein the first adhesive layer or the second adhesive layer defines an orifice that encircles the first opening and the second opening.

2. The electronic device of claim 1, further comprising:
a third adhesive layer on the second mesh layer opposite the second adhesive layer; and
a third mesh layer on the third adhesive layer opposite the second mesh layer.

3. The electronic device of claim 2, wherein:
the first mesh layer has a first acoustic impedance;
the second mesh layer has a second acoustic impedance greater than the first acoustic impedance; and
the third mesh layer has a third acoustic impedance greater than the first acoustic impedance and the second acoustic impedance.

4. The electronic device of claim 1, wherein the other of the first adhesive layer or the second adhesive layer defines a third opening and a fourth opening.

5. The electronic device of claim 1, wherein both the first adhesive layer and the second adhesive layer each define an orifice that encircles the first opening and the second opening.

6. The electronic device of claim 1, wherein a length of the orifice is greater than a length of the first mesh layer or the second mesh layer.

7. The electronic device of claim 1, wherein:
the orifice of the one of the first adhesive layer or the second adhesive layer comprises a first orifice; and
the one of the first adhesive layer or the second adhesive layer further defines a second orifice.

8. A speaker seal comprising:
a first adhesive layer;
a first mesh layer adhered to the first adhesive layer, the first mesh layer having a first length;
a second adhesive layer comprising an opening having a second length greater than the first length; and
a second mesh layer adhered to the second adhesive layer, the second mesh layer having a higher acoustic impedance than the first mesh layer.

9. The speaker seal of claim 8, further comprising a third mesh layer adhered to the first adhesive layer opposite the first mesh layer.

10. The speaker seal of claim 9, wherein the third mesh layer has a lower acoustic impedance than both the first mesh layer and the second mesh layer.

11. The speaker seal of claim 9, wherein the third mesh layer, the second mesh layer, and the second adhesive layer have a third length greater than the second length.

12. The speaker seal of claim 8, wherein the second adhesive layer comprises a protrusion defining a second opening having a third length less than the second length, the protrusion covering at least a portion of the second mesh layer.

13. The speaker seal of claim 8, wherein the first adhesive layer defines a plurality of openings.

14. The speaker seal of claim 8, wherein the speaker seal has an acoustic impedance of less than 65 Rayls and an ingress protection rating of at least IPX4.

15. An electronic device comprising:
a housing sidewall defining a first speaker opening, a second speaker opening, and a third speaker opening;
a housing rear wall;
a speaker module attached to the housing rear wall; and
a speaker seal attached to the housing sidewall, the speaker seal comprising:
a first adhesive layer attached to the housing sidewall; and
a first mesh layer attached to the first adhesive layer, the first adhesive layer defining a channel having a length that encircles two of the first speaker opening, the second speaker opening, and the third speaker opening.

16. The electronic device of claim 15, further comprising a second adhesive layer attached to the housing sidewall, the second adhesive layer encircling the first adhesive layer and the first mesh layer.

17. The electronic device of claim 16, wherein the second adhesive layer comprises a channel having a length that encircles the first speaker opening, the second speaker opening, the third speaker opening, the first adhesive layer, and the first mesh layer.

18. The electronic device of claim 17, further comprising a second mesh layer attached to the second adhesive layer, the second mesh layer having a second acoustic impedance greater than a first acoustic impedance of the first mesh layer.

19. The electronic device of claim 18, further comprising:
a third adhesive layer attached to the housing sidewall; and
a third mesh layer attached to the third adhesive layer, wherein the first adhesive layer and the second adhesive layer are attached to the housing sidewall through the third mesh layer.

20. The electronic device of claim 17, wherein the second adhesive layer comprises a protrusion aligned with the first speaker opening.
